(19) United States
(12) Patent Application Publication
(10) Pub. No.: US 2006/0257633 A1
(43) Pub. Date: Nov. 16, 2006

(54) Method for modifying surface of polymer substrate, method for forming plated film on polymer substrate, method for producing polymer member, and coating member

(75) Inventors: Kazuko Inoue, Ryugasaki City (JP); Katsusuke Shimazaki, Toride (JP); Atsushi Yusa, Toride City (JP); Toshinori Sugiyama, Tsukaba City (JP)

Correspondence Address: OLIFF & BERRIDGE, PLC, P.O. BOX 19928, ALEXANDRIA, VA, 22320, US

(73) Assignee: HITACHI MAXELL, LTD., Ibaraki-shi (JP)

(21) Appl. No.: 11/410,953

(22) Filed: Apr. 26, 2006

(30) Foreign Application Priority Data
Apr. 27, 2005 (JP) 2005-128996
Oct. 6, 2005 (JP) 2005-293491
Oct. 19, 2005 (JP) 2005-303916
Apr. 21, 2006 (JP) 2006-117937

(51) Int. Cl. B05D 5/00; B05D 3/00; B05D 1/40; B32B 27/00

(52) U.S. Cl. 428/195.1; 427/299; 427/331; 427/258; 428/411.1

(57) ABSTRACT

A method for modifying the surface of a polymer substrate is provided, which includes applying a permeating substance to predetermined region on the surface of the polymer substrate, and bringing a supercritical fluid into contact with the surface of the polymer substrate to which the permeating substance has been applied to cause the permeating substance to permeate into the polymer substrate. This method makes it possible to selectively (partially) modify a portion of the surface of the polymer substrate by an easier method.

### BACKGROUND OF THE INVENTION

1. Field of the Invention

The present invention relates to a method for modifying a surface of a polymer substrate with a supercritical fluid, a method for forming a plated film on the surface of a polymer substrate, a method for producing a polymer member, and a coating member used in these methods.

2. Description of the Related Art

Various processes have been proposed in recent years which use a supercritical fluid, which has permeability like a gas as well as which functions as a solution like a liquid, for the molding and processing of polymer substrates. For example, in Japanese Patent Application Laid-open No. 10-128783, since the supercritical fluid is able to lower the viscosity of a polymer substrate by acting as a plasticizer by permeating into a thermoplastic resin, a method for improving the fluidity and transferability of a polymer substrate during injection molding by utilizing this action of the supercritical fluid is proposed.

For example, Japanese Patent Application Laid-open No. 2001-226874 and Japanese Patent Application Laid-open No. 2002-129464 propose various methods for enhancing the function of a polymer substrate, such as improving the surface wettability thereof, by utilizing the solvent function of a supercritical fluid. Japanese Patent Application Laid-open No. 2001-226874 discloses that a fiber surface can be made to be hydrophilic by dissolving polyalkyl glycol in the supercritical fluid to bring into contact with the fibers. In addition, Japanese Patent Application Laid-open No. 2002-129464 discloses a batch process for enhancing the function of a polymer substrate surface by performing dyeing by bringing a polymer substrate into contact with a supercritical fluid, in which a functional material in the form of a solute has been preliminarily dissolved in a supercritical state, i.e., at a high pressure.

In addition, Japanese Patent Application Laid-open No. 2002-313750proposes a method for forming a pattern of adhered substance of 100 μm or less in a substrate surface by providing a mask, in which holes of a predetermined shape have been formed, on a substrate, and spraying a supercritical fluid, in which a substance (metal complex) to be adhered is dissolved, onto the substrate from above the mask.

### SUMMARY OF THE INVENTION

The above-mentioned Japanese Patent Application Laid-open Nos. H10-128783, 2001-226874 and 2002-129464 disclose methods for modifying the surface of a polymer substrate by using a supercritical fluid as a solvent, and disclose technologies for modifying the entire surface of a polymer substrate. However, it is difficult to selectively and precisely modifying a portion of the surface of a polymer substrate with the technologies disclosed in these documents. In addition, in Japanese Patent Application Laid-open No. 2002-313750, there is the fear of the following problems occurring since a substance (solute) is dissolved in a supercritical fluid and sprayed onto a polymer substrate.

There is a strong correlation between the pressure of a supercritical fluid and the solubility of a solute. When a supercritical fluid in which a solute has been dissolved is released to the outside from a container under high pressure into which the supercritical fluid has been filled, the pressure of the supercritical fluid decreases suddenly, and the solubility of the solute decreases remarkably. Namely, as is described in Japanese Patent Application Laid-open No. 2002-313750, in the case of dissolving a solute in a supercritical fluid and spraying the supercritical fluid onto a polymer substrate, deposition of the solute occurs when the supercritical fluid is sprayed. Consequently, in the technology described in Japanese Patent Application Laid-open No. 2002-313750, although the solute can be deposited on the surface of the polymer substrate, t the surface of the polymer substrate cannot be modified by permeating the solute into the polymer substrate together with the supercritical fluid permeating into the polymer substrate.

Moreover, in Japanese Patent Application Laid-open No. 2002-313750, although a method is disclosed for partially adhering a substance (metal complex) in a selected region of a substrate surface with a supercritical fluid, this method requires a process in which the mask is produced separately from the substrate, thereby resulting in the problem of increased costs. In addition, in the method disclosed in Japanese Patent Application Laid-open No. 2002-313750, since a mask is only set on a substrate, a gap is formed between the mask and the substrate and a supercritical fluid penetrates into the gap, thereby resulting in the fear of it being difficult to form a desired pattern by adhering the substance (metal complex) to the substrate according to the pattern of holes provided in the mask.

The present invention has been made in order to solve the above-mentioned problems, an object of the present invention is to provide a simpler method for selectively (partially) modifying a portion of the surface of a polymer substrate with a supercritical fluid, while also more precisely and finely modifying a portion of the surface of a polymer substrate, a method for forming a plated film on a polymer substrate, a method for producing a polymer member, and a coating member used therein.

According to a first aspect of the present invention, there is provided a surface modification method for a polymer substrate with a supercritical fluid, comprising:

applying a permeating substance to a surface of the polymer substrate; and

bringing the supercritical fluid into contact with the surface of the polymer substrate, to which the permeating substance has been applied, to cause the permeating substance to permeate into the polymer substrate.

In the method for modifying the surface of the polymer substrate of the present invention, the permeating substance may be applied, in a predetermined pattern, to the surface of the polymer substrate when the permeating substance is applied to the surface of the polymer substrate.

The applicant of this application has previously proposed a technology for modifying the surface of a polymer substrate by preliminarily coating a permeating substance onto the surface of a polymer substrate and then bringing a supercritical fluid into contact with the surface of the polymer substrate in Japanese Patent Application No. 2004-129235 (Japanese Patent Application Laid-open No. 2005-305945). In this technology, the following method was proposed as a method for selectively modifying a portion of the surface of a polymer substrate. First, a permeating substance to be permeated into the surface of the polymer substrate is coated over an entirety or a large portion of the surface of the polymer substrate. Next, a metal mold surface having a predetermined concave-convex pattern is made to have a contact with the surface of the polymer substrate. Next, a supercritical fluid is injected into the space formed between the metal mold (concave portion) and polymer substrate surface to selectively permeate the coated permeating substance into only the region of the polymer substrate surface into which the supercritical fluid was injected.

Another object of the present invention is to provide a simpler method for selectively (partially) modifying a portion of the surface of the polymer substrate without using the metal mold in which a fine concave-convex pattern has been formed as in the method for selectively modifying a portion of the surface of the polymer substrate proposed in the above-mentioned Japanese Patent Application No.2004-129235 (Japanese Patent Application Laid-open No. 2005-305945).

An explanation of the method for modifying the surface of the polymer substrate of the present invention will be made with reference to FIGS. 1A and 1B. First, as shown in FIG. 1A, a permeating substances 2 is selectively (partially) applied to a portion of the surface of a polymer substrate 1 in advance (the permeating substance is applied in a predetermined pattern on the surface of the polymer substrate) Next, as shown in FIG. 1B, in, for example, a sealed container 11, a supercritical fluid 5 makes contact with the surface of the polymer substrate 1 to which the permeating substance 2 has been applied. When this is done, the permeating substance 2 permeates into the polymer substrate 1 together with the supercritical fluid 5. As a result, as shown in FIG. 1C, a polymer substrate 1 is obtained in which the permeating substance 2 has only permeated into the portion of the polymer substrate 1 to which the permeating substance 2 has been applied. Namely, the polymer substrate 1 (polymer member) is obtained in which only the portion of the surface of the polymer substrate 1 to which the permeating substance 2 has been applied, is modified.

Furthermore, in FIG. 1C, although an example is shown in which a portion of the permeating substance 2 has permeated into the polymer substrate 1, the present invention is not limited thereto. For example, all of the applied permeating substance 2 maybe permeated into the polymer substrate 1. The permeation amount of the permeating substance 2 can be arbitrarily controlled by changing conditions such as the temperature, pressure and contact time of the contacting supercritical fluid 5, and in the surface modification method of the present invention, the permeation amount of the permeating substance 2 may be suitably adjusted according to the application and so on.

In the method for modifying the surface of the polymer substrate of the present invention as described above, since the metal mold having the fine concave-convex pattern, which is used in the above-mentioned Japanese Patent Application No. 2004-129235 (Japanese Patent Application Laid-open No. 2005-305945), is not required, production costs can be reduced. In addition, the process can also be simplified. In addition, since the permeating substance is applied to the surface of the polymer substrate in advance in a desired pattern in the method for modifying the surface of the polymer substrate of the present invention, the problem of deposition of the permeating substance when the pressure of the supercritical fluid decreases, which occurs when the permeating substance is made contact with the polymer in the state that the permeating substance has been dissolved in the supercritical fluid, is resolved. On the basis of the above, according to the method for modifying the surface of the polymer substrate of the present invention, the permeating substance is able to permeate into the polymer substrate in a short period of time and at a high concentration.

In the method for modifying the surface of the polymer substrate of the present invention, the surface of the polymer substrate may be pressed with a supercritical fluid at a suitable pressure by controlling the pressure of the supercritical fluid in the state in which the supercritical fluid has made contact with the surface of the polymer substrate (e.g., FIG. 1B). The permeating substance can be made to permeate deeper into the polymer substrate by this pressing. In addition, the supercritical fluid softens the surface of the polymer substrate by acting as a plasticizer for the polymer substrate as described above. For this reason, during bring the supercritical fluid into contact with the surface of the polymer substrate, or after that, when the surface of the polymer substrate is pressed with a metal mold and so on, since the permeating substance is able to efficiently permeate into the polymer substrate while inhibiting deformation of the polymer substrate, a more precise pattern can be formed on the surface of the polymer substrate.

In the method for modifying the surface of the polymer substrate of the present invention, the supercritical fluid may be carbon dioxide in a supercritical state (to also be referred to as a supercritical carbon dioxide). Furthermore, various substances may be used as the supercritical fluid, and nitrogen in the supercritical'state (to also be referred to as a supercritical nitrogen) may be used in addition to the supercritical carbon dioxide. Furthermore, the supercritical carbon dioxide is particularly optimal since it has previously been used as a plasticizer for thermoplastic resins in injection molding and extrusion molding. In addition, air, water, butane, pentane or methanol in a supercritical state may also be used as the supercritical fluid, and any such substance may be used provided that it dissolves the permeating substance to a certain degree. In addition, acetone or alcohols such as methanol, ethanol or propanol may be mixed with the supercritical fluid to act as an entrainer, namely, auxiliary agent, for improving the solubility of the permeating substance in the supercritical fluid.

Furthermore, in the present invention, although the temperature, pressure and other conditions of the supercritical fluid contacted with the polymer substrate are arbitrary, in the case of, for example, carbon dioxide having threshold values for the critical state consisting of a temperature of about 31° C. and a pressure of about 7 MPa or more, the temperature is preferably within the range of 35 to 150° C. and the pressure is preferably within the range of 10 to 25 MPa. When the temperature and pressure deviate from these ranges, the solubility of the permeating substance in the supercritical fluid and the permeability of the permeating substance into the polymer substrate become inadequate.

In the method for modifying the surface of a polymer substrate of the present invention, the polymer substrate may be formed of a material selected from the group consisting of polymethyl methacrylate, polycarbonate, wholly aromatic polyamide, wholly aromatic polyester and amorphous polyolefin. In addition, materials having these materials as their main component may also be used. Moreover, in the surface modification method of the present invention, various resins may also be used for the polymer substrate in addition to the above listed resins. For example, polylactic acid, polyamide, polyether imide, polyamide imide, polyester, polyacetal, polymethyl pentene, polytetrafluoroethylene, liquid crystal polymers, styrene-based resins, polymethylpentene, polyacetal, ABS plastic or the like, compound mixtures thereof, polymer alloys having these as their main component, and various types of thermoplastic resins, in which these resins are blended with various types of fillers, may also be used.

In the method for modifying the surface of the polymer substrate of the present invention, the permeating substance is an organic matter. In addition, the permeating substance may be dissolved in the supercritical fluid. In the case of using the organic matter which dissolves in the supercritical fluid for the permeating substance, since the permeating substance permeates into the polymer substrate in the state of being dissolved in the supercritical fluid, the permeating substance easily permeates into the polymer substrate.

In addition, the substance which permeates into the surface of the polymer substrate, which is generically referred to as a “permeating substance” in the present invention, may naturally be various organic materials (organic matters) or an inorganic material modified with an organic compound, and any material may be used provided that it dissolves in the supercritical fluid to a certain degree. Various materials can be used for the permeating substance according to the purpose and application. An example of an inorganic material used as the base of the permeating substance is a metal alkoxide. Specific examples of substances able to be used in the surface modification method of the present invention, along with their effects, are explained below.

In the method for modifying the surface of the polymer substrate of the present invention, the permeating substance may be a coloring matter. In the case of using, for example, an azo-based dye or organic dye material such as a fluorescent dye or phthalocyanine for the permeating substance, the surface of the polymer substrate can be dyed.

In the method for modifying the surface of the polymer substrate of the present invention, the permeating substance may be polyethylene glycol. In the case of using, for example, polyethylene glycol, polypropylene glycol, polyalkyl glycol or the like for the permeating substance, the surface of the polymer substrate can be made to be hydrophilic. Since polyethylene glycol in particular dissolves in the supercritical carbon dioxide, it easily permeates into the polymer substrate comparatively, and has hydrophilic groups (OH). For this reason, a polymer substrate having a hydrophilic surface can be produced in the case of using polyethylene glycol for the permeating substance. In addition, a polymer substrate, which has been made to be hydrophilic by using polyethylene glycol having superior biocompatibility, is suitable for use as a polymer substrate used in biochip and micro TAS (micro total analysis system). For example, the effect of controlling the anchoring of nucleic acids or proteins can be achieved by making the surface of a hydrophobic polymer substrate hydrophilic, or nucleic acids can be separated according to the rate of hydrophobicity thereof by dividing the surface of a polymer substrate into hydrophilic and hydrophobic micro regions.

In the method for modifying the surface of the polymer substrate of the present invention, the permeating substance may be a metal complex. In the case of using an organic metal complex for the permeating substance, a catalyst core of electroless plating can be formed on the surface of the polymer substrate. In this case, the method for modifying the surface of the polymer substrate of the present invention may further include forming a plated layer by electroless plating at a region to which the metal complex has been applied.

In addition, in the method for modifying the surface of a polymer substrate of the present invention, the permeating substances indicated below may also be used. In the case of using a hydrophobic UV stabilizer such as benzophenone or coumarin for the perm eating substance, the tensile strength after weathering of the polymer substrate can be improved. In addition, in the case of using a fluorine compound such as a fluorinated organic copper complex for the permeating substance, the friction properties of the polymer substrate can be improved or the polymer substrate can be given a water-repelling function. Moreover, a water-repelling function is developed in the case of using silicon oil for the permeating substance.

In addition, in the method for modifying the surface of a polymer substrate of the present invention, a material which does not dissolve in the supercritical fluid may be used for the permeating substance. In the case of using a permeating substance which does not dissolve in the supercritical fluid, the permeating substance, which has been partially applied (coated) to the polymer substrate surface when the supercritical fluid made contact with the polymer substrate surface, permeates into the polymer substrate due to the pressure of the supercritical fluid. In this case, although an arbitrary material may be used for the material used for the permeating substance, a material having a molecular weight of 5000 or less in particularly may be used in consideration of the molecular size of the permeating substance capable of easily permeating into the polymer substrate. However, in the case of using an inorganic material such as metal fine particles, carbon nanotubes, pullulan, nanocarbon such as nanohorn, titanium oxide or the like, these inorganic materials may be treated to be soluble in the supercritical fluid by chemical or physical modification.

In the method for modifying the surface of the polymer substrate of the present invention, a method in which the permeating substance is liquefied and then applied by a printing method such as screen printing or ink jet printing may be used to selectively (partially) apply the permeating substance to the surface of the polymer substrate. In addition, it may be employed an another method in which a metal mask or resist mask produced by photolithography is placed on the polymer substrate and then a solution containing the permeating substance is coated on the polymer substrate. Although examples of methods for liquefying the permeating substance include softening the permeating substance by heating or dissolving the permeating substance in a predetermined solvent, dissolving the permeating substance in a solvent is preferable due to the ease thereof since it is not necessary to control the temperature.

In the method for modifying the surface of the polymer substrate of the present invention, the applying of the permeating substance to the surface of the polymer substrate may include forming a predetermined groove pattern in the surface of the polymer substrate, and applying the permeating substance to the groove pattern.

In the method for modifying the surface of a polymer substrate of the present invention, a predetermined concave-convex pattern may be provided in the surface of the polymer substrate to which the permeating substance is applied (region of a predetermined pattern in which the surface is to be modified) by molding process or cutting process. For example, when a groove pattern is formed on the surface of the polymer substrate, the groove pattern can be used as a guide when applying the permeating substance to a portion (predetermined pattern) of the surface of the polymer substrate.

As described above, in the case of applying the permeating substance to the flat surface of the polymer substrate by a printing such as screen printing or ink jet printing, it is technically difficult to form a fine pattern of 100 μm or less at present. In addition, in the case of applying the permeating substance to the flat surface of the polymer substrate, there is the fear of it being difficult to form a fine pattern due to bleeding and so forth of the pattern of the permeating substance when the supercritical fluid makes contact with the polymer substrate surface. However, in the case that the concave-convex pattern having a width or depth of, for example, 100 μm or less, preferably 50 μm or less, and more preferably 10 μm or less, is formed on the surface of the polymer substrate, and the permeating substance is applied to the concave-convex pattern by, for example, ink jet printing, the permeating substance spreads along the concave-convex pattern due to capillary phenomenon, and a finer pattern of the permeating substance can be formed on the polymer substrate surface.

In addition, when the permeating substance is applied within the concave-convex pattern on the polymer substrate, since the permeating substance exists into the concave-convex pattern, elution and diffusion of the permeating substance in the horizontal direction (the plane direction of the polymer substrate) can be inhibited by the sidewalls of the concave-convex pattern when the supercritical fluid makes contact with the polymer substrate surface, thereby making it possible to inhibit the bleeding of the pattern of the permeating substance. Therefore, even a finer pattern of the permeating substance can be formed on the polymer substrate surface with high precision. Furthermore, although a concave pattern such as a groove pattern is preferable for the concave-convex pattern formed on the polymer substrate surface, a convex pattern may also be formed and the trough between convex patterns may be used. Moreover, the pattern of the permeating substance formed on the polymer substrate may also be composed not only of the above-mentioned concave and/or convex portions, but also in combination with the pattern of a permeating substance formed on the flat portion of the polymer substrate.

In addition, the above-mentioned method for applying the permeating substance within the concave-convex pattern on a polymer substrate is effective in the case of forming a fine pattern such as a hydrophilic channel on a polymer substrate, in particular, in the case of applying to a device which controls a liquid such as a biochip or μTAS. For example, when concave grooves are formed on the polymer substrate and the permeating substance is applied to the grooves and then concave grooves are hydrophilic, there is the effect which facilitates the flow of the liquid such as the specimen or reagent along the grooves due to capillary phenomenon acting on the concave grooves.

Moreover, the above-mentioned method for applying a permeating substance to a concave-convex pattern on a polymer substrate is also effective in the case of forming a wiring pattern such as an electrical circuit on a polymer substrate. In the case of forming a wiring pattern on a polymer substrate, first a metal complex is used for the permeating substance, and that permeating substance is applied to the wiring pattern portion of the polymer substrate to form a pattern of plated cores. Subsequently, a metal is deposited along the pattern of plated cores by electroless plating and the like to form a wiring pattern. As described above, in the case of forming the wiring pattern on the polymer substrate, a concave-convex pattern corresponding to the wiring pattern to be formed is preliminarily formed on the polymer substrate, and when a pattern of the metal complex is formed in the concave or convex portions of the polymer substrate, the deposition of metal is controlled as a result of the concave or convex portions serving as guides during electroless plating, thereby enabling the wiring pattern to be formed without increasing the wiring width.

In the method for modifying the surface of the polymer substrate of the present invention, the surface of the polymer substrate to which the permeating substance may be to be applied has a three-dimensional structure.

According to the method for modifying the surface of the polymer substrate of the present invention as described above, the surface of a polymer substrate can be partially modified by applying the permeating substance to only the region of a predetermined pattern on the surface of the polymer substrate, followed by bringing the supercritical fluid into contact with the polymer substrate surface. Therefore, the surface of the polymer substrate can be modified selectively and finely.

In addition, according to the method for modifying the surface of the polymer substrate of the present invention, since the permeating substance is applied to a predetermined region of the polymer substrate surface by a method such as ink jet printing or screen printing when a fine pattern of the permeating substance is formed on the polymer substrate surface, the surface can be modified at low cost and the process is simplified since a metal mold is not required to form the fine pattern.

Moreover, in the method for modifying the surface of the polymer substrate of the present invention, since permeating substances developing various functions can be permeated into the polymer substrate, the functions of the permeating substance are sustained, making it possible to provide a functional polymer substrate (member) having superior weather resistance.

In addition, in the method for modifying the surface of the polymer substrate of the present invention, the applying of the permeating substance to the surface of the polymer substrate may include: forming a mask layer, in contact with the polymer substrate, the mask layer having an opening in a predetermined pattern; and applying a permeating substance to at least the opening of the mask layer. An example of this surface modification method is briefly explained with reference to FIGS. 10A to 10E.

First, a mask layer 44 is formed on a preliminarily provided a polymer substrate 41. At this time, as shown in FIG. 10A, the mask layer 44 is formed at regions other than a region 42 where the surface is to be modified on the polymer substrate 41. Namely, the mask layer 44 is formed so that the region 42 where the surface is to be modified on the polymer substrate 41 becomes an opening. Next, a permeating substance layer 45 is formed on the mask layer 44 (the permeating substance is at least applied to the opening in the mask layer). In the example of FIG. 10B, the permeating substance layer 45 was formed not only over the region 42 of the polymer substrate 41, which is exposed in the opening of the mask layer 44, but also over the region other than the opening of the mask layer 44. Furthermore, the present invention is not limited thereto, but rather the permeating substance layer 45 is only required to at least be formed at the opening in the mask layer 44, and is not required to be formed at a region other than the opening in the mask layer 44.

Next, a supercritical fluid 46 makes contact with the permeating substance layer 45 side of the polymer substrate 41 (state shown in FIG. 10B). At this time, a portion of the permeating substance layer 45 formed on the region 42 (the region 42 in which the surface is to be modified on the polymer substrate 41) of the polymer substrate 41 exposed in the opening of the mask layer 44 permeates into the surface of the polymer substrate 41 through the region 42 in the surface therein together with the supercritical fluid 46. As a result, as shown in FIG. 10C, the permeating substance 43 permeates only into the region 42 on the surface of the polymer substrate 41. Next, the permeating substance that has not permeated into the polymer substrate 41 is removed (state shown in FIG. 10D). Finally, when the mask layer 44 is removed, a surface-modified polymer substrate 40′ (polymer member) is obtained in which the permeating substance 43 has been selectively permeated into only the predetermined region 42 on the polymer substrate 41 as shown in FIG. 10E.

As described above, in the case that the mask layer, which provides an opening at a predetermined region where the surface is to be modified on the polymer substrate, was preliminarily formed on the polymer substrate by a printing, the permeating substance is made to permeate through the opening into the polymer substrate with the supercritical fluid, thereby making it possible to selectively modify a predetermined region of the polymer substrate. Therefore, in this method as well, since the predetermined region on the surface of the polymer substrate can be partially modified without using a metal mold formed a fine concave-convex pattern, it is not necessary to produce individual metal molds corresponding to the pattern of a region at which the surface is to be modified on the polymer substrate surface, thereby making it possible to lower costs and simplify the process.

In addition, in the case that a mask layers which provides an opening at a predetermined region where the surface is to be modified on a polymer substrate, was preliminarily formed on the polymer substrate by a printing, since the mask layer, which provides an opening at a predetermined region where the surface is to be modified on the polymer substrate, is formed by being tightly adhered to the polymer substrate, a supercritical carbon dioxide, in which a permeating substance is dissolved, does not penetrate between the mask layer and the polymer substrate, thereby making it possible to modify the surface of the polymer substrate in a predetermined pattern with higher precision.

In the method for modifying the surface of the polymer substrate of the present invention, the polymer substrate may be prepared such that at least one of a concave portion and a convex portion is formed on the surface of the polymer substrate, the at least one of the concave portion and the convex portion corresponding to an opening of the mask layer.

As described above, in the case that a region where the surface is to be modified on a polymer substrate (a region corresponding to an opening of a mask layer) is formed on at least one of a concave portion and convex portion, the concave portion and convex portion can serve as a guide when forming a pattern of a permeating substance on the polymer substrate. Moreover, the pattern of a permeating substance formed on the polymer substrate may be composed of not only a concave portion and/or convex portion, but also may be in combination with a pattern of a permeating substance formed on the flat portion of the polymer substrate.

In the method for modifying the surface of the polymer substrate of the present invention, the mask layer is formed of a polymer material. Any material can be used for the mask layer provided it is capable of blocking a supercritical fluid, is a material which adheres/tightly-adheres to the surface of the polymer substrate, and is able to be removed without leaving blemish on the polymer substrate after performing the treatment in which a supercritical fluid makes contact with the polymer substrate. The penetration of a supercritical fluid into the region of the polymer substrate to which the mask layer is adhered/tightly-adhered can be prevented by forming the mask layer from a material having these properties. A polymer material, for example, can be used for a material having these properties, and examples of materials which can be used include photosensitive resins, thermoplastic resins and thermosetting resins. A photosensitive resin is particularly preferable since it allows a predetermined pattern to be formed easily and facilitates tightly adhering to the polymer substrate, and examples of materials which may be used include materials in which an oligomer such as polyester acrylate, epoxy acrylate, urethane acrylate or silicone acrylate is blended into a base. In addition, in the case of using a thermoplastic resin for the polymer substrate, Positive Resist 1805 (Shipley Far East) may be used. This photosensitive resin material is able to block the supercritical fluid, and together with being a material that adheres/tightly-adheres to the surface of the polymer substrate, allows the use of propanol, butanol, ethanol or methanol at the time of removal, thereby enabling treatment to be carried out without damaging the polymer substrate during removal of the mask layer.

Furthermore, in the method for modifying the surface of the polymer substrate of the present invention, in order to block the supercritical fluid and in order to inhibit a damage to the polymer substrate at a region other than the opening of the mask layer, a substrate layer which brings out the above-mentioned effects may also be provided between the mask layer and the polymer substrate.

In the method for modifying the surface of the polymer substrate of the present invention, the mask layer may be formed by a printing. Although any method can be used for the method for forming the mask layer provided that it is able to form a mask layer in which the region where the surface to be modified of the polymer substrate is in the form of an opening, a mask layer can be formed in particular by adhering and hardening a mask material such as a liquefied photo sensitive resin at a region other than a region of a polymer substrate where the surface is to be modified by a printing such as screen printing or ink jet printing. In addition, it maybe employed an another method in which a photosensitive resin is coated over the entire surface of a polymer substrate and then the photosensitive resin at the location where the surface of the polymer substrate is to be modified is removed by using a metal mask or photolithography to form a mask layer. Furthermore, although examples of methods for liquefying the mask material include a method in which the mask material is softened by heating or a method in which the mask material is dissolved in a predetermined solvent, dissolving the mask material in a solvent is preferable due to the ease thereof since it is not necessary to control the temperature.

The method for modifying the surface of the polymer substrate of the present invention may further include forming a coating layer so as to cover the permeating substance after the applying of the permeating substance to the surface of the polymer substrate. In addition, the permeating substance may be applied, in a predetermined pattern, to the surface of the polymer substrate when the permeating substance is applied to the surface of the polymer substrate.

The inventors of the present invention also discovered the following as a result of conducting diligent research on a method for selectively modifying a portion of the surface of a polymer substrate by applying a permeating substance in a predetermined pattern on the polymer substrate by an ink jet printing or screen printing as described above, and bringing a supercritical fluid into contact with the surface of the polymer substrate on the side of the applied the permeating substance to permeate the permeating substance into the polymer substrate.

When the supercritical fluid makes contact with the polymer substrate to which the permeating substance has been applied to permeate the permeating substance into the polymer substrate, it was found that, depending on the conditions of that contact and so on, there is the fear that a portion of the permeating substance elutes into the supercritical fluid and the permeating substance does not efficiently permeate into the polymer substrate. In addition, it was also found that, in the above-mentioned surface modification method, when the supercritical fluid makes contact with the polymer substrate to which a permeating substance has been applied in the predetermined pattern, there is the fear that the bleeding of the pattern occurs due to elution of the permeating substance applied to the polymer substrate surface into the supercritical fluid. Therefore, the inventors of the present invention further improved the above-mentioned surface modification method based on the above findings. An example of that method for modifying the surface of the polymer substrate is explained with reference to FIGS. 11A to 11E.

First, as shown in FIG. 11A, a permeating substance 2 is preliminarily applied to a predetermined region (all or a predetermined portion thereof) where the surface of a polymer substrate 1 is to be modified (the permeating substance 2 is applied to the surface of the polymer substrate 1 in a predetermined pattern). Next, as shown in FIG. 11B, a coating agent is applied so as to cover the permeating substance 2 to form a coating layer 4. Furthermore, although the coating layer 4 is formed over the entire surface of the polymer substrate 1 in the example shown in FIG. 11B, the present invention is not limited thereto. Since, the coating layer 4 is only required to at least be formed at a region able to the cover permeating substance 2, the coating layer 4 may also be formed at a portion of the polymer substrate surface which is able to cover the permeating substance 2. In addition, the coating layer 4 is preferably solidified or gelled according to need, thereby enabling to prevent flowing, outflow and so on of the coating layer 4.

Next, as shown in FIG. 11C, the polymer substrate 1 on which the coating layer 4 has been formed is arranged in, for example, a sealed container 11, a supercritical fluid 5 is introduced into the sealed container 11, and the supercritical fluid 5 is made contact with the surface on the coating layer 4 side of the polymer substrate 1. As a result, the supercritical fluid 5 first permeates into the coating layer 4 and then reaches the permeating substance 2 to dissolve the permeating substance 2. The supercritical fluid 5 then permeates into the polymer substrate 1 together with the permeating substance 2 dissolved therein. At this time, although the permeating substance 2 is in a fluid state dissolved in supercritical fluid 5, since the permeating substance 2 is covered by the coating layer 4, the permeating substance 2 does not scatter to the outside from the vicinity of the surface of the polymer substrate 1. As a result of the action of this coating layer 4, the permeating substance 2 dissolved in the supercritical fluid 5 efficiently permeates into the polymer substrate 1 at a high concentration. In addition, since the permeating substance 2 is covered by the coating layer 4, diffusion of the permeating substance 2 dissolved in the supercritical fluid in the direction of the plane of the polymer substrate 1 can be inhibited when the permeating substance 2 permeates into the polymer substrate 1, thereby enabling the permeating substance 2 to permeate without bleeding of the predetermined pattern of the permeating substance 2 applied to the polymer substrate 1. Therefore, a region of the predetermined pattern where the surface of the polymer substrate 1 is to be modified can be modified with high precision.

The polymer substrate 1 is then taken out from the sealed container 11 after the permeating substance 2 has permeated into the polymer substrate 1 in the manner described above (state shown in FIG. 11D). Finally, the coating layer 4 covering the permeating substance 2 is washed off with a suitable solvent (state shown in FIG. 11E). At that time, any permeating substance 2 remaining on the polymer substrate 1 may also be removed.

In the method for modifying the surface of the polymer substrate of the present invention, the coating layer may be formed by a method selected from the group consisting of dipping, roll coating, screen printing, and spraying. Furthermore, any method can be used for applying the coating layer on the permeating substance of the polymer substrate provided it is a method that allows the coating layer to be applied so as to at least cover the portion to which the permeating substance is applied, and various known addition methods can be used in addition to the above-mentioned method. The thickness of the coating layer may be of any thickness provided it is thickness that facilitates permeation of the supercritical fluid and prevents diffusion of the permeating substance, and the thickness of the coating layer may be suitably set corresponding to the polymer substrate used, the permeating substance and so on. Furthermore, the thickness of the coating layer is typically within the range of 5 to 200 μm, and is preferably uniform.

A material that can allow adequate permeation of the supercritical fluid and inhibit diffusion of the permeating substance may be selected for the material of the coating layer able to be used in the method for modifying the surface of the polymer substrate of the present invention. Since the formation of the coating layer with a material having these properties allows the supercritical fluid in which the permeating substance is dissolved to lead the surface of the polymer substrate and also enable the supercritical fluid to make contact with the polymer substrate while inhibiting diffusion of the permeating substance from the polymer substrate surface, the permeating substance can be efficiently permeated into the polymer substrate at a high concentration. In addition, in the method for modifying the surface of the polymer substrate of the present invention, the coating layer may be formed of a material which has lower solubility in the supercritical fluid than the permeating substance.

Various types of water-soluble resins (water-soluble polymers) may be used for the material of the coating layer having the above-mentioned properties. Examples of water-soluble resins include polyvinyl alcohol, polyvinyl pyrrolidone, starch, methyl cellulose, carboxymethyl cellulose, sodium alginate and the like. In addition, examples of other materials for forming the coating layer which can be used include polyethylene oxide, sodium polyacrylate, polyacrylamide, cellulose, polyethylene glycol, polyvinyl pyrrolidone and the like. In the case of forming the coating layer with a water-soluble resin, when removing the coating layer after having permeated the permeating substance into the polymer substrate, since the coating layer can be removed by rinsing the polymer substrate with water, the coating layer can be removed without damaging the polymer substrate.

In the method for modifying the surface of the polymer substrate of the present invention, the polymer substrate may be prepared such that a region of the predetermined pattern is formed in a concave portion of the polymer substrate. In addition, the concave portion may include a groove pattern.

In addition, in the method for modifying the surface of the polymer substrate of the present invention which includes the formation of the coating layer so as to cover a permeating substance after applying the permeating substance to a predetermined region on the surface of the polymer substrate, the applying of the permeating substance to the surface of the polymer substrate may include: forming of a mask layer having an opening, in a predetermined pattern, on the polymer substrate; and applying of the permeating substance to at least the opening of the mask layer. An example of this method for modifying the surface of a polymer substrate is explained with reference to FIGS. 13A to 13F.

First, a mask layer 76 is formed on a polymer substrate 41. At this time, the mask layer 76 is formed at a region other than a region 77 where the surface is to be modified on the polymer substrate 41 as shown in FIG. 13A. Namely, the mask layer 76 is formed so as to form an opening at the region 77 where the surface is to be modified on the polymer substrate 41. Next, a permeating substance (substance which permeates into the polymer substrate 41) layer 72 is formed on the mask layer 76 (state shown in FIG. 13B). At this time, although the permeating substance layer 72 is formed not only on the region 77 of the polymer substrate 41, which is exposed in the opening of the mask layer 76, but also over the entire surface of the mask layer 76 in the example of FIG. 13B, the present invention is not limited thereto, but rather the permeating substance layer 72 is only required to at least be formed in the opening of the mask layer 76, and is not required to be formed at regions other than the opening in the mask layer 76.

Next, as shown in FIG. 13C, a coating layer 73 is formed by applying a coating agent on the permeating substance layer 72. Furthermore, although the coating layer 73 is formed over the entire surface of the permeating substance layer 72 in the example of FIG. 13C since the permeating substance layer 72 is formed over the entire surface of the mask layer 76, the present invention is not limited thereto. In the case the permeating substance layer 72 is only formed at a portion of the region which includes an opening in the mask layer 76, the coating layer 73 is only required to be formed so as to cover the permeating substance layer 72, and in this case, the coating layer 73 may be formed at a partial region so as to cover the permeating substance layer 72 formed at a partial region, or the coating layer 73 may be formed over the entire surface of the polymer substrate.

Next, as shown in FIG. 13D, the polymer substrate 41 on which the coating layer 73 has been formed is arranged in, for example, a sealed container 11, a supercritical fluid 5 is introduced into the sealed container 11, and the supercritical fluid 5 is made contact with the surface on the coating layer 73 side of the polymer substrate 41. As a result, the supercritical fluid 5 first permeates into the coating layer 73 and then reaches the permeating substance layer 72 to dissolve the permeating substance. At this time, the permeating substance applied to the region 77 of the polymer substrate 41 exposed in the opening of the mask layer 76 is also dissolved by the supercritical fluid 5. As a result, a portion of the permeating substance layer 72 formed on the region 77 of the polymer substrate 41 exposed in the opening of the mask layer 76 permeates into the polymer substrate 41 from the region 77 on the surface thereof together with the supercritical fluid 5, thereby resulting in a state in which the permeating substance only has permeated the region 77 on the surface of the polymer substrate 41 as shown in FIG. 13D. At this time, although the permeating substance layer 72 is in a fluid state dissolved in the supercritical fluid 5, since the permeating substance layer 72 is covered by the coating layer 73 and the mask layer 76, it does not scatter to the outside from the vicinity of the surface of the polymer substrate 41. As a result of the action of the coating layer 73 and the mask layer 76, the permeating substance dissolved in the supercritical fluid 5 efficiently permeates into the polymer substrate 41 at a high concentration.

Next, polymer substrate 41 is taken out from a sealed container 11 (state shown in FIG. 13D). Finally, the coating layer 73, the permeating substance layer 72 and the mask layer 76 on the polymer substrate 41 are washed off with a suitable solvent (state shown in FIG. 13F). At this time, although the films (or layers) formed on the polymer substrate 41 may be removed in order starting with the uppermost portion, by removing the mask layer 76 with a solvent, the coating layer 73 and the permeating substance layer 72 on the mask layer 76 may also be removed together.

In the case of forming a mask layer and a coating layer so as to cover a permeating substance as described above, when a supercritical fluid makes contact with a polymer substrate to permeate a permeating substance into the polymer substrate, the permeating substance dissolved in the supercritical fluid can be permeated into a polymer substrate without scattering to the outside from the polymer substrate surface, and diffusion of the permeating substance dissolved in the supercritical fluid in the plane direction of the polymer substrate can be inhibited, thereby making it possible to prevent bleeding of the pattern of the permeating substance. Therefore, in the method for modifying the surface of a polymer substrate of the present invention, in the case of having formed a mask layer and a coating layer so as to cover a permeating substance, the permeating substance can be efficiently permeated at a high concentration. In addition, a predetermined region of the polymer substrate surface can be modified more finely and with high precision.

Moreover, in the method for modifying the surface of the polymer substrate of the present invention, the applying of the permeating substance to the surface of the polymer substrate may include: applying the permeating substance, in a predetermined pattern, on a surface of a coating film; and arranging the coating film on the polymer substrate.

In addition, in this surface modification method, the arranging of the coating film on the polymer substrate may include laminating the coating film and the polymer substrate so that the surface of the coating film to which the permeating substance has been applied faces the surface of the polymer substrate. An example of this method for modifying the surface of a polymer substrate is explained with reference to FIGS. 14A to 14E.

First, a permeating substance 2 (substance which permeates into a polymer substrate 1) is applied in a predetermined pattern to a coating film 80 (state shown in FIG. 14A). Furthermore, a material listed in the explanation of the material used to form the above-mentioned coating layer may be used for the material used to form coating film 80, and may be formed of a water-soluble resin in particular.

Next, as shown in FIG. 14B, the coating film 80 is arranged on the polymer substrate 1 so that the surface of the coating film 80 to which the permeating substance 2 has been applied faces the surface of the polymer substrate 1. At this time, as shown in FIG. 14B, the permeating substance 2 may be tightly adhered to the surface of the polymer substrate 1 by laminating the polymer substrate 1 and the coating film 80 so as to be tightly adhered together.

Laminating the polymer substrate 1 and the coating film 80 after interposing water, ethanol, methanol or the like there between is an effective method for tightly adhering the polymer substrate 1 to the coating film 80. More specifically, after dropping a small amount of water, ethanol or methanol onto the surface of the polymer substrate 1, the coating film 80 is then mounted thereon so that the surface of the coating film 80 to which the permeating substance 2 has been applied opposes the polymer substrate 1. Next, pressure may be gradually applied to the surface of coating film 80 starting from the edge thereof while avoiding entrance of air to be tightly adhered the coating film 80 to the polymer substrate 1. When laminating in this manner, although it is preferable to interpose volatile liquid such as water, alcohol or the like between the coating film and the polymer substrate to tightly adhere the two while preventing the entrance of air followed by evaporating the liquid, a liquid, which does not dissolve or decompose the coating film, polymer substrate or permeating substance, may be suitably selected for the liquid.

Next, the polymer substrate 1 laminated with the coating film 80 is arranged in, for example, a sealed container 11 as shown in FIG. 14C, a supercritical fluid 5 is introduced into the sealed container 11, and the supercritical fluid 5makes contact with the surface of the polymer substrate 1 on the side of the coating film 80. As a result, the supercritical fluid 5 first permeates into the coating film 80, and then reaches the permeating substance 2 to dissolve the permeating substance 2. The supercritical fluid 5 then permeates into the polymer substrate 1 together with the permeating substance 2 dissolved therein. At this time, although the permeating substance 2 is in a fluid state dissolved in the supercritical fluid 5, since the permeating substance 2 is covered by the coating film 80, it does not scatter to the outside from the vicinity of the surface of the polymer substrate 1.

After the permeating substance 2 has permeated into the polymer substrate 1 in the manner described above, the polymer substrate 1 is taken out from the sealed container 11 (state shown in FIG. 14D). Finally, the coating film 80 covering the permeating substance 2 is washed off with a suitable solvent (state shown in FIG. 14E). In the above-mentioned method for modifying the surface of a polymer substrate, since a coating film, in which a permeating substance has been preliminary applied in a predetermined pattern to a polymer substrate, can be supplied in the form of a roll-like sheet, it is possible to realize general versatility in manufacturing and lower costs such as by being able to accommodate diverse forms of polymer substrates, while also being able to improve productivity.

In a method for modifying the surface of a polymer substrate of the present invention as described above, in the case of having brought a supercritical fluid into contact with a polymer substrate in the state in which a permeating substance is covered with a coating film, since the permeating substance dissolved in the supercritical fluid permeates into the polymer substrate without being scattered to the outside from the polymer substrate surface, the permeating substance can be permeated more efficiently and at a high concentration.

In addition, in the method for modifying the surface of a polymer substrate of the present invention, in the case of a permeating substance being by a coating film, when the permeating substance permeates the polymer substrate, diffusion of the permeating substance dissolved in a supercritical fluid in the direction of the plane of the polymer substrate can be inhibited, thereby making it possible to inhibit bleeding of the pattern of the permeating substance. Therefore, a predetermined region of the polymer substrate surface can be modified more finely and with high precision.

According to a second aspect of the present invention, there is provided a method for forming a plated film in a predetermined pattern on a surface of a polymer substrate, comprising:

applying a metal complex to the surface of the polymer substrate;

bringing a supercritical fluid into contact with the surface of the polymer substrate to cause the metal complex to permeate into the polymer substrate;

forming a plated film at a region which includes a region corresponding to the predetermined pattern on the surface of the polymer substrate into which the metal complex has permeated; and

forming a mask layer for patterning the plated film in the predetermined pattern.

In the method for forming a plated film proposed in the above-mentioned Japanese Patent Application No. 2004-129235 (Japanese Patent Application Laid-open No. 2005-305945), metal fine particles are permeated in a predetermined pattern (e.g., wiring circuit) into a flat polymer surface by using a metal mold in which a fine concave-convex pattern has been formed, followed by forming a plated film thereon. At this time, since the plated film grows not only in the direction of thickness of the plated film, but also in the plane direction of the plated film, the pattern width of the plated film increases as the thickness of the plated film increases. Therefore, in the case of, for example, forming a plated film having a narrow pitch pattern, and increasing the thickness of the plated film to ensure electrical conductivity of the plated film, when the plated film is formed by using the surface modification technology disclosed in the above-mentioned Japanese Patent Application No. 2004-129235, the pattern width increases and there is the fear that it is difficult to form a narrow pitch pattern. In addition, since the technology of the above-mentioned Japanese Patent Application No. 2004-129235 uses a metal mold in which a fine concave-convex pattern has been formed, there is also the risk of it being difficult to form a plated film in a predetermined pattern on the surface of a polymer substrate having a three-dimensional shape. Therefore, another object of the present invention is to form a plated film in a predetermined pattern on a polymer substrate by an easier method without using a metal mold in which a fine concave-convex pattern has been formed as proposed in the above-mentioned Japanese Patent Application No. 2004-129235, as well as form a plated film in a fine predetermined pattern with high precision on a polymer substrate by an easier method for the surface of a polymer substrate having a three-dimensional shape.

In the method for forming the plated film of the present invention, after permeating the metal complex into the polymer substrate, the mask layer, in which a region corresponding to the predetermined pattern is an opening, may be formed on the surface of the polymer substrate into which the metal complex has permeated, and the plated film may be formed in the opening of the mask layer. In addition, the forming of the plated film in the opening of the mask layer may include: forming a first plated film by electroless plating on a portion of the surface of the polymer substrate, the portion being exposed in the opening of the mask layer, and forming a second plated film by electrolytic plating on the first plated film.

In this method for forming the plated film, a metal complex is first applied to a predetermined region of the surface of the polymer substrate. Furthermore, at this time, the predetermined region of the polymer substrate to which the metal complex is applied may be any region provided it contains the region where the plated film is to be formed (the region corresponding to the predetermined pattern; to be referred to as the predetermined pattern region), and the metal complex may be applied over the entire surface of the polymer substrate or only at the predetermined pattern region of the plated film. In addition, when applying the metal complex, the metal complex may be coated onto the polymer substrate surface in a state of being contained in a solvent such as hexane, acetone, ethyl alcohol, methyl alcohol or the like. Furthermore, examples of methods which can be used to apply the metal complex to the polymer substrate surface include any method such as a method in which the polymer substrate is immersed directly in a complex solution (dipping), spray coating ink jet printing or the like. Dipping is particularly preferable due to the ease thereof.

Next, a supercritical fluid makes contact with the polymer substrate. As a result, the metal complex permeates into the surface of the polymer substrate together with the supercritical fluid. In this step, it was determined by the inventors of the present invention on the basis of verification experiments that, only by permeating the metal complex into the surface of the polymer substrate together with the supercritical fluid, but an adequate amount of the metal complex is reduced to metal fine particles which serve as the plating base (catalyst cores) of the plated film. However, reduction treatment of the metal complex may also be carried out separately by using a reducing agent and so on to reliably segregate an adequate amount of metal fine particles on the surface of the polymer substrate.

After having permeated the plating base of the plated film into the surface of the polymer substrate, a mask layer, in which an opening is formed to a predetermined pattern region of the plated film, is formed on the polymer substrate surface. Next, when electroless plating is carried out on the polymer substrate on which the mask layer is formed, a first plated film is formed on the polymer substrate surface exposed in the opening of the mask layer. Next, when electrolytic plating (electro forming) is carried out by using the first plated film as an electrode, a second plated film is formed on the first plated film, and a plated film composed of the first and second plated films is formed on the polymer substrate. When the mask layer is removed, a polymer substrate is obtained in which a plated film is formed on the surface thereof in a predetermined pattern. When a plated film is formed by the above-mentioned method, a high-quality plated film can be formed easily in a desired pattern, and a fine, high-precision plated film pattern such as wiring can be formed.

Furthermore, since the mask layer is provided at a region other than the predetermined pattern region of the plated film in the above-mentioned method for forming a plated film, the pattern width of the plated film is not larger than the dimensions (width) of the opening in the mask layer. Therefore, the above-mentioned method for forming a plated film allows the formation of a highly precise plated film pattern even in cases in which a plated film having a narrow pitch pattern is formed at an adequate thickness.

Furthermore, although the plated film is formed by electroless plating and electrolytic plating in the above-mentioned method for forming a plated film, this is done for the reasons indicated below. When the plated film is formed on a polymer substrate by electroless plating and electrolytic plating, the plated film of adequate thickness can be formed in a shorter period of time, thereby making it possible to improve production speed (mass productivity). In addition, since plated films formed by electrolytic plating are typically known to have superior film quality (electrical conductivity, hardness, etc.) as compared with plated films formed by electroless plating, the use of the method described above makes it possible to form a high-quality plated film on a polymer substrate in a short period of time.

In addition, the method for forming the plated film of the present invention, after permeating the metal complex into the polymer substrate, a first plated film may be formed by electroless plating on the surface of the polymer substrate to which the metal complex has permeated; the mask layer, in which a region corresponding to the predetermined pattern is an opening, may be formed on the first plated film; a second plated film may be formed by electrolytic plating on a portion of the first plated film, the portion being exposed in the opening of the mask layer; the mask layer may be removed; and the first plated film formed at a region other than the region corresponding to the predetermined pattern may be removed by etching.

In this method for forming a plated film, after having permeated a metal complex into a predetermined region of a polymer substrate surface, electroless plating is carried out to form a first plated film on the polymer substrate surface. Next, a mask layer is formed on the first plated film so as to provide an opening to a region corresponding to the predetermined pattern of the plated film. Next, when electrolytic plating is carried out by using the first plated film as an electrode, a second plated film is formed on the first plated film exposed in the opening of the mask layer, and a plated film composed of the first and second plated films is formed on the polymer substrate.

Next, the mask layer is removed, and the surface of the polymer substrate is etched by an etching method such as reactive ion etching or wet etching. At this time, since only the first plated film is present in a region other than the predetermined pattern region of the plated film, and the thickness thereof is less than the thickness of the plated film formed in the predetermined pattern region (first and second plated films), the first plated film formed in the region other than the predetermined pattern region is removed prior to the plated film formed in the predetermined pattern region by the etching process. As a result, since only the plated film formed in the opening of the mask layer remains, a polymer substrate, in which the plated film of a predetermined pattern is formed on the surface thereof, is obtained. Therefore, use of the above-mentioned method makes it possible to easily form a high-quality plated film in a desired pattern, and to form a fine and highly precise plated film pattern such as wiring.

In addition, in the method for forming the plated film of the present invention, after permeating the metal complex into the polymer substrate, the plated film may be formed on the surface of the polymer substrate to which the metal complex has permeated; the mask layer may be formed on a region of the plated film, the region corresponding to the predetermined pattern; and the plated film may be removed by etching at a region in which the mask layer is absent. In addition, the forming of the plated film on the surface of the polymer substrate to which the metal complex has permeated may include: forming a first plated film by electroless plating on the surface of the polymer substrate to which the metal complex has permeated, and forming a second plated film by electrolytic plating on the first plated film.

In this method for forming a plated film, a first plated film is formed on the surface of a polymer substrate by carrying out electroless plating after having permeated a metal complex into a predetermined region of the surface of the polymer substrate, and then a second plated film is formed on the first plated film by carrying out electrolytic plating by using the first plated film as an electrode. Next, a mask layer is formed on the region of the second plated film corresponding to the predetermined pattern region of the plated film. Namely, a mask layer is formed on the second plated film so as to cover the predetermined pattern region of the plated film. Next, the surface of the polymer substrate is etched by an etching method such as wet etching or reactive ion etching. At this time, the plated film (first and second plated films) formed at a region where the mask layer is not formed (region other than the predetermined pattern region) is removed by etching, and only the plated film (first and second plated films) at the predetermined pattern region of the plated film remains. When the mask layer is removed, a polymer substrate is obtained in which a plated film is formed on the surface thereof in a predetermined pattern. Therefore, use of the above-mentioned method makes it possible to easily form a high-quality plated film in a desired pattern, and to form a fine and highly precise plated film such as wiring.

The method for forming a plated film of the present invention may further include forming a coating film so as to cover the metal complex after the applying of the metal complex to the surface of the polymer substrate.

In the case a coating layer is formed so as to cover the metal complex applied to the polymer substrate, when a supercritical fluid makes contact with the polymer substrate, the supercritical fluid first permeates into the coating layer and then reaches the metal complex to dissolve the metal complex. The supercritical fluid then permeates into the polymer substrate together with the metal complex dissolved therein. At this time, although the metal complex is in a fluid state dissolved in the supercritical fluid, since the metal complex is covered by the coating layer, it is not scattered to the outside from the vicinity of the surface of the polymer substrate. Namely, diffusion of the metal complex to the side of the supercritical fluid can be inhibited. Due to the action of this coating layer, the metal complex dissolved in the supercritical fluid is able to efficiently permeate into the polymer substrate at a high concentration.

Furthermore, the coating layer is only required to at least be formed in the region able to be cover the metal complex, and may be formed over the entire surface of the polymer substrate, or may be formed in a partial region that contains the region to which the metal complex has been applied. In addition, the coating layer is preferably solidified or gelled according to need, thereby enabling to prevent flowing, outflow and so on of the coating layer.

A material, which allows adequate permeation by the supercritical fluid, and inhibits diffusion of the metal complex, is preferably selected for the material of the coating layer able to be used in the method for forming a plated film of the present invention. More specifically, the same material used for the coating layer explained in the above-mentioned method for modifying the surface of a polymer substrate according to a first aspect of the present invention may be used.

In the method for forming the plated film of the present invention, the mask layer may be formed by one method selected from spraying, dipping, roll coating, screen printing, and ink jet printing. Ink jet printing may be used in the case of forming a mask layer on the surface of a polymer substrate having a three-dimensional shape in particular. Furthermore, a photosensitive resin material such as a UV curable resin is preferable for the material used to form a mask layer in the method for forming a plated film of the present invention.

In the method for forming the plated film of the present invention, the polymer substrate may be formed of a material selected from the group consisting of polymethyl methacrylate, polycarbonate, wholly aromatic polyamide, wholly aromatic polyester and amorphous polyolefin. In addition, a material explained in the method for modifying the surface of a polymer substrate of the present invention may also be used as a polymer substrate in addition to the materials described above.

In the method for forming a plated film of the present invention, a Cu film, Ni film, Au film, Ag film or the like can be used for the plated film. In addition, the metal complex is preferably a substance which dissolves in the supercritical fluid, and in the case of using the supercritical carbon dioxide for the supercritical fluid, examples of metal complexes which can be used include bis(acetylacetonato)palladium, platinum dimethyl(cyclooctadiene), bis(cyclopentadienyl)nickel, bis(acetylacetonato)palladium and hexafluoroacetylacetonato palladium.

In the method for forming a plated film of the present invention, in the case of using a Cu film for the second plated film (plated film formed by electrolytic plating), although the film thickness thereof can be set arbitrarily according to the application and so on, the second plated film is preferably formed in a thickness of 10 to 100 μm. When the thickness of the second plated film is less than 10 μm, it becomes difficult to make the electrical resistance as circuit wiring adequately small. In addition, when the thickness of the second plated film exceeds 100 μm, the second plated film easily cracks and exfoliates. In addition, in the case of using a Cu film for the first plated film (plated film formed by electroless plating), the thickness thereof is preferably 1 to 2 μm. In the case of using the first plated film as an electrode of electrolytic plating, since the electrical resistance of the first plated film becomes high when the thickness thereof is less than 1 μm, the thickness of the first plated film is preferably 1 μm or more. In addition, since there are no changes in performance as an electrode even when the thickness of the first plated film is greater than 2 μm, in the case of using the first plated film as an electrode of electrolytic plating, the thickness of the first plated film is not required to be so thick, and a thickness of 2 μm is adequate.

According to the method for forming a plated film of the present invention, since plated films are formed by electroless plating and electrolytic plating (electro forming) steps after a metal complex has been permeated into the surface of a polymer substrate with a supercritical fluid and patterning of the plated film is performed by using the mask layer, a high-quality plated film can easily be formed into a desired pattern, and fine and highly precise plated film pattern can be formed on a polymer substrate.

In addition, according to the method for forming a plated film of the present invention, since a plated film can be formed in a predetermined pattern on the surface of a polymer substrate without using a metal mold in which a fine concave-convex pattern has been formed on the surface thereof as in the technology disclosed in the above-mentioned Japanese Patent Application No. 2004-129235 (Japanese Patent Application Laid-open No. 2005-305945), a simpler method than the method for forming a plated film described in the above-mentioned Japanese Patent Application No. 2004-129235 can be provided.

Moreover, in the method for forming a plated film of the present invention, in the case of forming a mask layer by ink jet printing, a plated film can be easily formed in a predetermined pattern even on the surface of a polymer substrate having a three-dimensional shape.

According to a third aspect of the present invention, there is provided a method for producing a polymer member, comprising:

preparing a polymer substrate;

applying a permeating substance to a surface of the polymer substrate; and

bringing a supercritical fluid into contact with the surface of the polymer substrate to which the permeating substance has been applied to cause the permeating substance to permeate into the polymer substrate.

In the method for producing the polymer member of the present invention, the permeating substance may be applied to the surface of the polymer substrate in a predetermined pattern when the applying of the permeating substance to the surface of the polymer substrate.

According to the above-mentioned method for producing a polymer member of the present invention, in addition to selectively (partially) modifying a portion of the surface of a polymer substrate by an easier method, a polymer member can be obtained in which a portion of the surface of a polymer substrate is modified highly precisely and finely.

In the method for producing a polymer member of the present invention, the supercritical fluid may be carbon dioxide in a supercritical state.

In the method for producing a polymer member of the present invention, the polymer substrate may be formed of a material selected from the group consisting of polymethyl methacrylate, polycarbonate, wholly aromatic polyamide, wholly aromatic polyester and amorphous polyolefin. In addition, a material explained in the method for modifying the surface of a polymer substrate of the present invention may also be used as a polymer substrate in addition to the materials described above.

In the method for producing a polymer member of the present invention, the permeating substance may be an organic matter. In addition, the permeating substance may dissolve in the supercritical fluid. More specifically, the permeating substance may be a coloring matter, or the permeating substance may be polyethylene glycol.

In addition, in the method for producing the polymer member of the present invention, the permeating substance may be a metal complex. In this case, the method for producing the polymer member of the present invention may further include forming a plated layer by electroless plating at a region to which the permeating substance has been applied.

In the method for producing the polymer member of the present invention, the permeating substance may be applied by a screen printing or an ink jet printing when the permeating substance is applied to the surface of the polymer substrate.

In the method for producing the polymer member of the present invention, the applying of the permeating substance to the surface of the polymer substrate may include forming a predetermined groove pattern in the surface of the polymer substrate, and applying the permeating substance to the groove pattern.

In the method for producing the polymer member of the present invention, the surface of the polymer substrate to which the permeating substance is to be applied may have a three-dimensional structure.

In the method for producing the polymer member of the present invention, the applying of the permeating substance to the surface of the polymer substrate may include forming a mask layer, in contact with the polymer substrate, the mask layer having an opening in a predetermined pattern, and applying the permeating substance to at least the opening of the mask layer.

The method for producing the polymer member of the present invention may further include forming a coating layer so as to cover the permeating substance after the applying the permeating substance to the surface of the polymer substrate.

In the method for producing the polymer member of the present invention, the applying of a permeating substance to the surface of the polymer substrate may include forming a mask layer, having an opening in a predetermined pattern, on the polymer substrate, and applying the permeating substance to at least the opening of the mask layer.

In the method for producing the polymer member of the present invention, the applying of a permeating substance to the surface of the polymer substrate may include applying the permeating substance in a predetermined pattern on a surface of a coating film, and arranging the coating film on the polymer substrate.

According to a fourth aspect of the present invention, there is provide a polymer substrate in which a surface thereof has been modified by using the surface modification method for the polymer substrate as defined in a first aspect of the present invention. In addition, according to a fifth aspect of the present invention, there is provided a polymer substrate in which a plated film formed in the predetermined pattern by the method for forming a plated film as defined in a second aspect of the present invention, is formed on the surface of the polymer substrate.

According to a sixth aspect of the present invention, there is provided a coating member which is used to modify a surface of a polymer substrate, comprising:

a coating film; and

a permeating substance applied on the coating film to modify the surface of the polymer substrate with a supercritical fluid.

In the coating member of the present invention, the permeating substance may be formed on the coating film in a predetermined pattern. In addition, the permeating substance may be an organic matter.

In the coating member of the present invention, the coating film may be formed of a material which has lower solubility in the supercritical fluid than the permeating substance. In addition, the coating film may be formed of a water-soluble substance.

### BRIEF DESCRIPTION OF THE DRAWINGS

FIGS. 1A to 1C show the procedure of the surface modification method of the present invention;

FIG. 2 is a perspective view of a polymer substrate produced in Example 1;

FIG. 3 is a schematic diagram showing a configuration of a high-pressure device used to modify the surface of a polymer substrate in Example 1;

FIG. 4 is a graph showing the distribution of the dye content in the direction of depth of the polymer substrate produced in Example 1;

FIGS. 5A and 5B are schematic diagrams showing a configuration of a micro TAS produced in Example 2, with FIG. 5A being a perspective view and FIG. 5B being a cross-sectional view taken along line A-A′ in FIG. 5A;

FIGS. 6A and 6B are schematic diagrams showing a configuration of a micro TAS produced in Example 3, with FIG. 6A being a perspective view and FIG. 6B being a cross-sectional view taken along line B-B′ in FIG. 6A;

FIGS. 7A and 7B are schematic diagrams showing a configuration of a lens module produced in Example 4, with FIG. 7A being a cross-sectional view taken along line C-C′ in FIG. 7B, and FIG. 7B being an overview view from the side of the three-dimensional surface;

FIG. 8 is a table showing the results of a peeling test of the three-dimensional wiring of a lens module produced in Example 4;

FIGS. 9A and 9B are schematic diagrams showing a configuration of a micro TAS produced in Example 5, with FIG. 9A being a perspective view and FIG. 9B being a cross-sectional view taken along line E-E′ in FIG. 9A;

FIGS. 10A to 10E are drawings showing the procedure of a method for forming a pattern of an organic matter on the polymer substrate of Example 5;

FIGS. 11A to 11E are drawings showing the procedure of the surface modification method of Example 6;

FIG. 12 is a graph showing the distribution of the dye content in the direction of depth of the polymer substrate produced in Example 6;

FIGS. 13A to 13F are drawings showing the procedure for the surface modification method of Example 10;

FIGS. 14A to 14E are drawings showing the procedure for the surface modification method of Example 11;

FIG. 15 is a series of drawings for explaining the procedure for the method for forming a plated film of Example 12;

FIG. 16 is a series of drawings for explaining the procedure for the method for forming a plated film of Example 13;

FIG. 17 is a series of drawings for explaining the procedure for the method for forming a plated film of Example 14;

FIG. 18 is a series of drawings for explaining the procedure for the method for forming a plated film of Variation 1; and

FIG. 19 is a series of drawings for explaining the procedure for the method for forming a plated film of Variation 2.

### DESCRIPTION OF THE PREFERRED EMBODIMENTS

Although the following provides a detailed explanation of examples of the method for modifying the surface of a polymer substrate and production methods thereof of the present invention with reference to the drawings, the present invention is not limited thereto.

### EXAMPLE 1

In Example 1, an explanation is provided of a method for carrying out surface modification by applying a dye 2 (permeating substance) to the surface of a polymer substrate 1 (polymer substrate) in a character pattern (“A” and “B”), and only allowing the dye 2 to permeate into the polymer substrate 1 only at that region as shown in FIG. 2.

### High-Pressure Device Used in Surface Modification Method

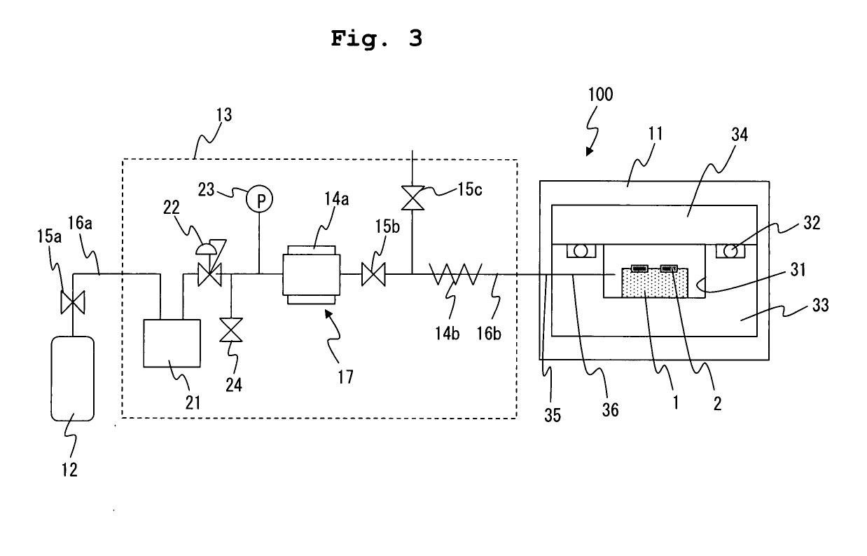

First, an explanation will be provided of the high-pressure device used in the surface modification method of Example 1 with reference to FIG. 3. FIG. 3 is a schematic diagram showing a configuration of a high-pressure device used in the surface modification method of this example. As shown in FIG. 3, a high-pressure device 100 is mainly composed of a high-pressure container 11, a CO₂ tank 12, a supercritical fluid regulator 13, and pipes 16a and 16b which connect these constituent elements.

As shown in FIG. 3, the high-pressure container 11 includes a container body 33, in which a recess 31 is formed in the surface thereof, and a cover 34, and is provided with an O-ring 32 on the upper surface of the outer wall of the recess 31 of the container body 33. As shown in FIG. 3, the recess 31 of the container body 33 is sealed by mounting the cover 34 on the upper surface of the recess side of the container body 33 and bolting thereto. In addition, as shown in FIG. 3, a channel 36 and an inlet port 35 communicated to the recess 31 of the container body 33 are formed in the high-pressure container 11. In addition, as shown in FIG. 3, the channel 36 is connected to the pipe 16b, through which an external supercritical fluid flows, via the inlet port 35, and the supercritical fluid formed outside of the high-pressure container 11 passes through the inlet port 35 and the channel 36 from the pipe 16b, and is efficiently introduced into the sealed recess 31 of the container body 33. At this time, since the recess 31 of the container body 33 is sealed by the cover 34 via the O-ring 32, the supercritical fluid that is introduced into the recess 31 via the inlet port 35 and the channel 36 does not leak to the outside of the high-pressure container 11.

As shown in FIG. 3, the supercritical fluid regulator 13 is mainly composed of a booster pump 21 and a buffer tank 17. The CO₂ tank 12 and the supercritical fluid regulator 13 are connected by the pipe 16a, and CO₂ gas which has been introduced into the supercritical fluid regulator 13 from the CO₂ tank 12 via the pipe 16a is introduced into the buffer tank 17 by the booster pump 21. The pressure of the introduced CO₂ gas is then increased to a predetermined pressure within the buffer tank 17 and the introduced CO₂ gas becomes CO₂ gas in a supercritical state (the supercritical carbon dioxide) which has been adjusted to a predetermined temperature by a heater 14a provided in the buffer tank 17. The supercritical carbon dioxide generated within the buffer tank 17 passes through the pipe 16b controlled to a predetermined temperature with a temperature controller 14b, and is introduced into the recess 31 from the inlet port 35 of the high-pressure container 11 via the channel 36.

Modification Method and Production Method for Polymer Substrate Next, an explanation is provided of the method for modifying the surface of a polymer substrate 1 of this example. First, the polymer substrate 1 having a flat surface was preliminarily prepared. Polycarbonate resin having a glass transition temperature Tg of about 130° C. was used for the polymer substrate 1. Next, a dye 2 (permeating substance) was applied to the surface of this polymer substrate 1 in a predetermined pattern (character pattern) by screen printing. In this example, characters of the alphabet in the form of “A” and “B” were formed for the pattern of the dye 2 as shown in FIG. 2 to evaluate the effects of partial surface modification. In addition, an alcohol solution of the dye, Blue 35, represented by the following chemical formula (1), was used for the dye 2 applied to the polymer substrate 1. Furthermore, the dye 2 was applied so that the coated thickness of the dye solution was about 15 μm. Next, the polymer substrate 1 coated with the dye 2 was dried for 1 hour at 70° C., followed by cooling for 1 hour at room temperature.

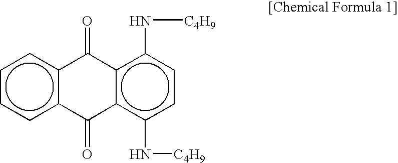

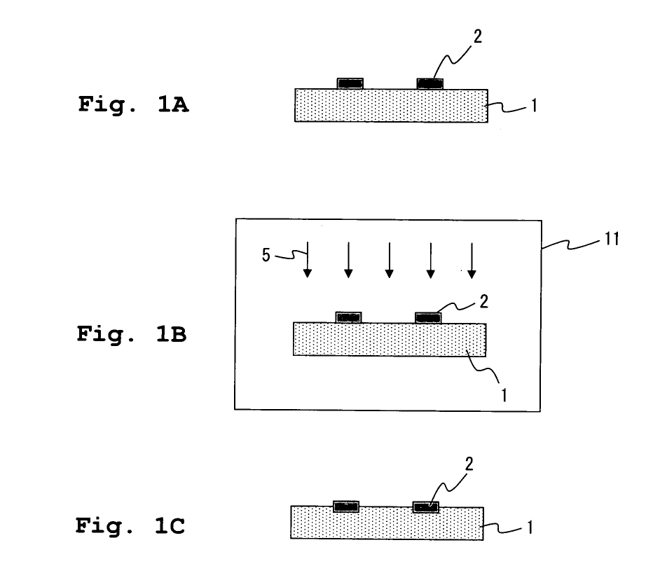

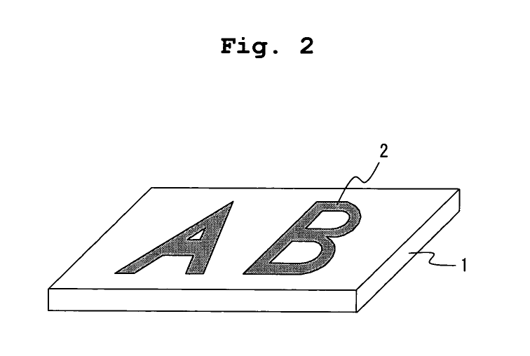

In the manner described above, a polymer substrate 1 was obtained in which the dye 2 was applied in a predetermined character pattern to the surface thereof as shown in FIG. 2. A schematic cross-sectional view of the polymer substrate 1 at this time is shown in FIG. 1A. At this time, the dye 2 is only coated on the polymer substrate 1, and has not permeated therein.

Next, the polymer substrate 1 was placed in the bottom of the recess 31 of the high-pressure container 11. Subsequently, the cover 34 was placed over the container body 33 and bolted thereon to seal the recess 31 within the high-pressure container 11. Next, the supercritical fluid was introduced into the recess 31 of the high-pressure container 11 in the manner described below. First, CO₂ gas is introduced into the buffer tank 17 from the CO₂ tank 12 via the booster pump 21 of the supercritical fluid regulator 13. The introduced CO₂ gas is then increased in pressure and heated within the buffer tank 17 to generate CO₂ in the supercritical state (the supercritical carbon dioxide) In this example, the supercritical carbon dioxide having a temperature of 40° C. and pressure of 15 MPa was generated. Next, a valve 15b is opened and the supercritical carbon dioxide controlled to a predetermined pressure within the buffer tank 17 is introduced into and retained in sealed the recess 31 within the high-pressure container 11 via the inlet port 35 and the channel 36 of the high-pressure container 11 (state shown in FIG. 1B).

Furthermore, since the pipe 16b, which connects the supercritical fluid regulator 13 and the high-pressure container 11, is controlled to a predetermined temperature by the temperature controller 14b (e.g., hot water circulating type temperature controller), the temperature of the supercritical carbon dioxide which passes through this pipe 16b can be controlled corresponding to the controlled temperature of the pipe. Therefore, the temperature within the recess 31 of the high-pressure container 11 into which the supercritical carbon dioxide has been introduced can also be controlled by the temperature controller 14b. Furthermore, although the temperature and pressure within the high-pressure container 11 changes as a result of adjusting the temperature of the supercritical fluid, the above-mentioned temperature and pressure conditions of the supercritical fluid in the present example indicate the state prior to introduction into the high-pressure container 11.

When the supercritical carbon dioxide 5, which has been introduced into the recess 31 of the high-pressure container 11, makes contact with the surface of the polymer substrate 1, the dye 2, which has been partially applied to the surface of substrate polymer 1, dissolves in the supercritical carbon dioxide and permeates into the polymer substrate 1 together with the supercritical carbon dioxide.

Next, after opening a release valve 24 within the supercritical fluid regulator 13 and opening the recess 31 within the high-pressure container 11 to the atmosphere, the polymer substrate 1 was taken out from the high-pressure container 11 (state shown in FIG. 1C).

A polymer substrate 1 (polymer member) is obtained in the state in which a character pattern of the dye 2 has permeated into the polymer substrate 1 as shown in FIG. 2 by the above-mentioned process. Namely, a polymer substrate 1 is obtained which is composed of a polymethyl methacrylate resin on which surface modification has been partially carried out with the dye 2.

As described above, in the method for modifying the surface of a polymer substrate of the present invention, since a permeating substance such as a dye can be preliminarily applied to a predetermined portion of a polymer surface by a printing such as screen printing, the surface of the polymer substrate can be partially modified without using a metal mold in which a fine concave-convex pattern has been formed. Therefore, it is not necessary to fabricate individual metal molds corresponding to a pattern formed on a polymer substrate surface, costs are low and the process can be simplified.

### Evaluation of Adhesion

The adhesion of the dye 2 formed on the surface of the polymer substrate 1 obtained in the above-mentioned process was evaluated. More specifically, adhesion was evaluated by immersing the polymer substrate 1 in isopropyl alcohol, which is a good solvent of the coloring material (dye). Furthermore, a polymer substrate was also produced, on which the above-mentioned surface modification treatment (treatment consisting of bringing into contact with a supercritical fluid to permeate the coloring material into the polymer substrate) was not carried out after applying the dye on the polymer substrate 1 by screen printing, for comparison purposes (to be referred to as the polymer substrate of Comparative Example 1), and the adhesion of the dye was also evaluated. As a result, the dye eluted and the printing disappeared when the polymer substrate of Comparative Example 1 was immersed in the isopropyl alcohol. However, there was no loss of color observed in the printed region (character pattern region) of the polymer substrate 1 produced in this example.

### Cross-Sectional Structure

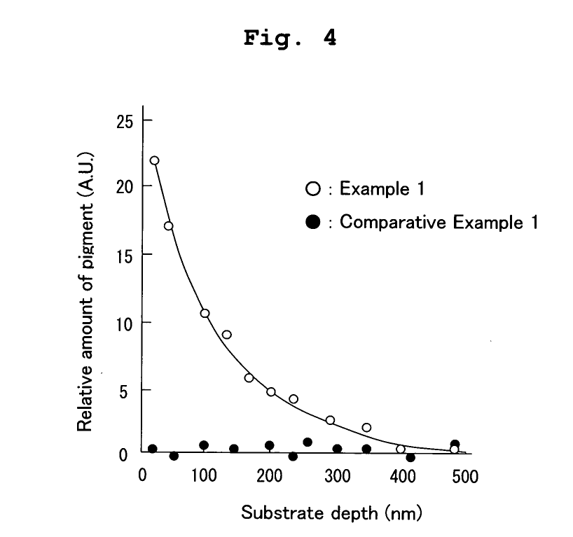

The state of the permeation of the permeating substance (dye) into the surface of the polymer substrate was analyzed for the polymer substrate produced in Example 1 (polymer substrate in which a predetermined surface region was partially modified) and the polymer substrate produced in Comparative Example 1. More specifically, the distribution of the dye concentration in the direction of thickness of the substrate at the portion to which the dye was applied to the polymer substrates of Example 1 and Comparative Example 1 was investigated. The measurement method consisted of etching the surface of the polymer substrate by sputtering, and measuring the change in the relative content of the dye by using electron spectroscopy for chemical analysis (ESCA) (the dye content at each measured depth relative to the dye content at a predetermined depth (in addition, the relative content is represented with an arbitrary scale)). Those results are shown in FIG. 4. In FIG. 4, the location of depth in the direction of thickness of the polymer substrate is represented on the horizontal axis, while the relative value of the dye content is represented on the vertical axis. Furthermore, the white circles in FIG. 4 represent the measured results for Example 1, while the black circles represent the measured results for Comparative Example 1. In addition, the 0 position on the horizontal axis indicates the uppermost position of the surface of the polymer substrate, and is the boundary with the printing layer (dye). Namely, in the characteristics of FIG. 4, the location of depth of the substrate becomes deeper toward to the right side in the graph. As is clear from FIG. 4, in the polymer substrate produced in Example 1, it was found out that the dye had permeated to a depth of about 400 nm from the vicinity of the uppermost surface of the polymer substrate. On the other hand, in the polymer substrate produced in Comparative Example 1, the dye was observed to have hardly permeated into the polymer substrate at all as is clear from FIG. 4.

As is clear from the above-mentioned results, it was found out that, in the polymer substrate produced in this example, the dye material had permeated from the surface of the polymer substrate to inside the polymer substrate at a higher concentration than a polymer substrate on which surface modification treatment was not carried out, and the region of the polymer substrate into which the dye had permeated was modified to a state in which the dye was resistant to exfoliate.

### EXAMPLE 2

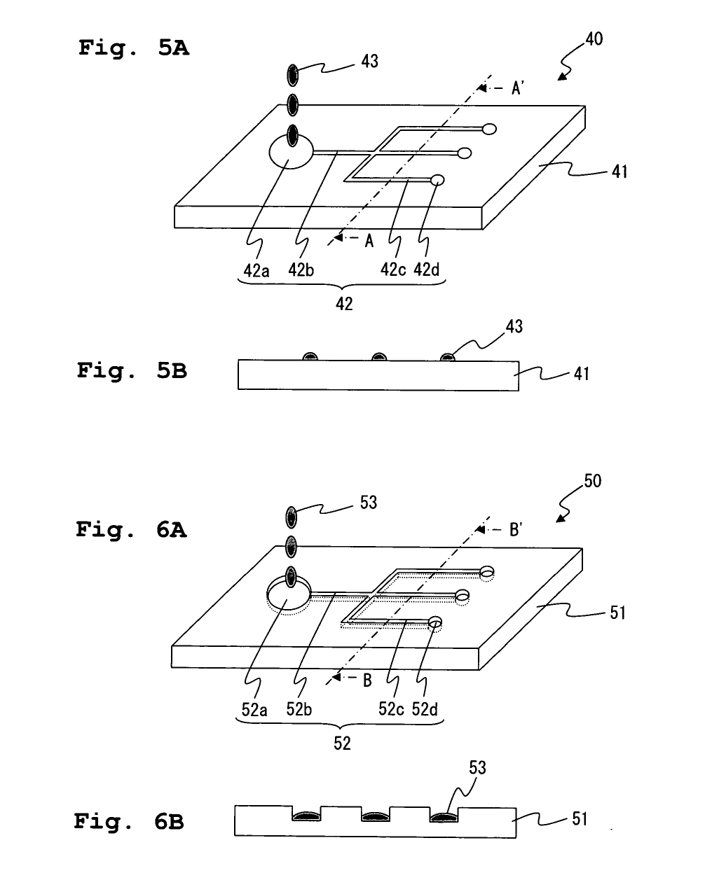

In Example 2, an example is explained in which the surface modification method of the present invention is applied to a plate used for biochemical analysis and so on referred to as micro TAS. The constitution of the micro TAS produced in this example is schematically shown in FIGS. 5A and 5B.

In the micro TAS 40 of this example, a pattern 42 of a permeating substance 43 as shown in FIG. 5A was formed on a polymer substrate 41. A polymer substrate made of polymethyl methacrylate resin and having a glass transition temperature Tg of about 100° C. (Asahi Chemical Industries, trade name: Delpet 560F) was used for the polymer substrate 41. Polyethyleneglycol (PEG) having an average molecular weight of about 1000 was used for the permeating substance 43 formed into the pattern 42. Namely, in this example, surface modification treatment was carried out which hydrophilized the surface region where the PEG 43 was applied by applying the PEG 43 to the surface of the polymer substrate 41 in a predetermined pattern and bringing into contact with a supercritical fluid.

As shown in FIG. 5A, the pattern 42 of the PEG 43 was composed of a circular portion 42a, into which a liquid sample is injected, a channel 42b, which extends from the circular portion 42a along the longitudinal direction of the polymer substrate 41, three branching channels 42c, which are branched from an intermediate point in the channel 42b, and three small circular portions 42d, into which a reagent is injected and which are respectively formed on the ends of the three branching channels 42c. Furthermore, in this example, the diameter of the circular portion 42a was made to be 5 mm, that of the small circular portions 42d was made to be 2 mm, and the widths of the channel 42b and the small channels 42c were made to be 300 μm. In this example, the surface of the polymer substrate 41 is flat. The pattern 42 of the PEG 43 was applied by printing on the polymer substrate 41 by screen printing. At this time, the PEG 43 softened by heating to 60° C. was applied to the surface of the polymer substrate 41 by screen printing.

Next, the polymer substrate 41, on which the pattern 42 of the PEG 43 had been formed by screen printing, was placed in the recess 31 of the high-pressure container 11 used in Example 1, and then sealed inside the high-pressure container 11. Next, a supercritical carbon dioxide made contact with the surface of the polymer substrate 41 to permeate the PEG 43 into the polymer substrate 41 in the similar manner as Example 1. Furthermore, at this time, the supercritical carbon dioxide having a pressure P of 15 MPa and temperature of 50° C. was introduced and retained in the high-pressure container 11, and after the pressure P of the supercritical carbon dioxide had stabilized, that state was maintained for 30 minutes. As a result, the PEG 43 coated onto the surface of the polymer substrate 41 dissolved in the supercritical carbon dioxide and permeated into the polymer substrate 41 together with the supercritical carbon dioxide. At this time, however, although the supercritical carbon dioxide made also contact with the region of the polymer substrate 41 to which the PEG 43 had not been applied, since the PEG 43 had not been applied to this region, the surface of the polymer substrate 41 was not modified at that region.

Next, the inside of the high-pressure container 11 was opened to the atmosphere in the similar manner as Example 1, and the polymer substrate 41 was taken out from the high-pressure container 11. In this manner, a micro TAS 40 (polymer member) made from polymethyl methacrylate resin was able to be obtained in which the PEG 43 had permeated into the surface of the polymer substrate 41 only at the region of the pattern 42, namely, the surface modification had been carried out only at the region to which the PEG 43 had been applied. In the micro TAS 40 produced in this example, only the surface of the polymer substrate 41 into which the PEG 43 had permeated (the pattern 42 region) was hydrophilized.

Next, the wettability of the surface of the micro TAS 40 of this example produced in the manner described above was evaluated. Furthermore, in this evaluation, a micro TAS on which surface modification treatment (treatment consisting of bringing into contact with a supercritical fluid to permeate PEG into a polymer substrate) was not carried out (to be referred to as the micro TAS of Comparative Example 2) was also produced for comparison purpose, and the wettability thereof was also evaluated. As a result, in the micro TAS of Comparative Example 2, in contrast to the contact angle of water at the region of the surface where PEG was applied being about 55°, in the micro TAS 40 of this example (the micro TAS which performed the surface modification treatment), the contact angle of water at the surface to which PEG was applied was about 100. Namely, as a result of carrying out the surface modification treatment (bringing into contact with the supercritical carbon dioxide) in the manner of micro TAS 40 produced in this example, it was found out that the wettability of the region to which PEG had been applied had to have been improved considerably (improved hydrophilicity). In addition, when water droplets were dropped onto the micro TAS 40 produced in this example in the vicinity of the circular portion 42a formed therein, it was confirmed that the water moved along the channel 42b and the branching channels 42c, and reached the small circular portions 42d.

In addition, the wettability of the micro TAS 40 of this example was again confirmed after immersing in water for 24 hours. As a result, there was hardly any change in the water contact angle. Moreover, after allowing the micro TAS 40 of this example to stand in air for 10 months, the wettability of the region to which the PEG was applied was confirmed. As a result, the water contact angle was found to be 13°, thus it was found out that satisfactory wettability was maintained. It was conceived that this is because the wettability is stably maintained due to the permeation of a high concentration of PEG into the polymer substrate.

### EXAMPLE 3

In Example 3, an example is explained in which the surface modification method of the present invention is applied to a micro TAS similarly as in Example 2. In this example, however, a preferable surface modification method is explained in the case of forming a finer permeating substance pattern in a polymer substrate as compared with that of Example 2.

Schematic diagrams showing a configuration of the micro TAS produced in this example are shown in FIGS. 6A and 6B. In the micro TAS 50 of this example, as shown in FIGS. 6A and 6B, a groove pattern 52 similar to the PEG pattern formed on the surface of the polymer substrate of the micro TAS produced in Example 2 was formed on the surface of a polymer substrate 51, and PEG 53 was applied into this groove pattern. In the micro TAS 50 of this example, the dimensions of the groove pattern 52 were as described below. The diameter of the circular portion 52a was 2 mm, the widths of the channel 52b and the branching channels 52c were each 100 μm, the diameter of the small circular portions 52d was 2 mm, and the depth of the circular portion 52a, the small circular portions 52d and the groove pattern 52 were each 100 μm. In addition, in this example, a polymethyl methacrylate (PMMA) resin was used for the polymer substrate 51, and polyethylene glycol (PEG) 53 was used for the permeating substance applied into the grove pattern 52. The micro TAS 50 of this example was produced in the manner described below.

First, a metal mold, in which a concave-convex pattern opposite that of the groove pattern 52 formed in the polymer substrate 51 was formed, was preliminarily prepared, and the polymer substrate 51, in which the groove pattern 52 was formed in the surface thereof as shown in FIGS. 6A and 6B, was produced by injection molding using this metal mold. Furthermore, in this example, although the concave-convex pattern in the metal mold was formed by precision machining, the concave-convex pattern may also be formed in the metal mold by applying lithography.

Next, as shown in FIG. 6A, PEG 53 was applied by ink jet printing along the groove pattern 52 of the polymer substrate 51 formed by the above-mentioned method. At this time, the PEG 53, which was in a softened state as a result of being heated to 60° C., was discharged from an ink jet head and applied into the groove pattern 52 formed in the surface of the polymer substrate 51. Furthermore, in the case the PEG 53 protruded from the groove pattern 52 in this step, the unnecessary PEG 53 may be removed by wiping with water or alcohol.

After having applied the PEG 53 into the groove pattern 52 of the polymer substrate 51, the supercritical carbon dioxide made contact with the surface of the polymer substrate 51 in the similar manner as in Example 2 to modify the surface of the polymer substrate 51 by causing the PEG 53 to permeate into the groove pattern 52 of the polymer substrate 51 (hydrophilization). The micro TAS 50 of this example was obtained in this manner. When a micro TAS is produced by the method described above, a permeating substance can be applied onto a polymer substrate in a pattern of 100 μm or less, making it possible to produce a micro TAS (polymer member) in which only the region of the fine pattern is modified.

In addition, the wettability of the micro TAS 50 produced in this example was evaluated in the similar manner as Example 2. As a result, results were obtained that were similar to those of Example 2. Namely, it was confirmed that the wettability was improved only in the pattern region into which the PEG had permeated, that region had become hydrophilic, and the wettability was stably maintained.

### EXAMPLE 4

In Example 4, an example is explained in which the method for modifying the surface of a polymer substrate of the present invention is applied to polymer surface having a three-dimensional surface. More specifically, in this example, an example is explained in which the method for modifying the surface of a polymer substrate of the present invention is applied when carrying out circuit wiring on a module substrate of a single-chip lens module which integrates a lens with an image sensor which detects images formed by the lens in the form of electrical signals.

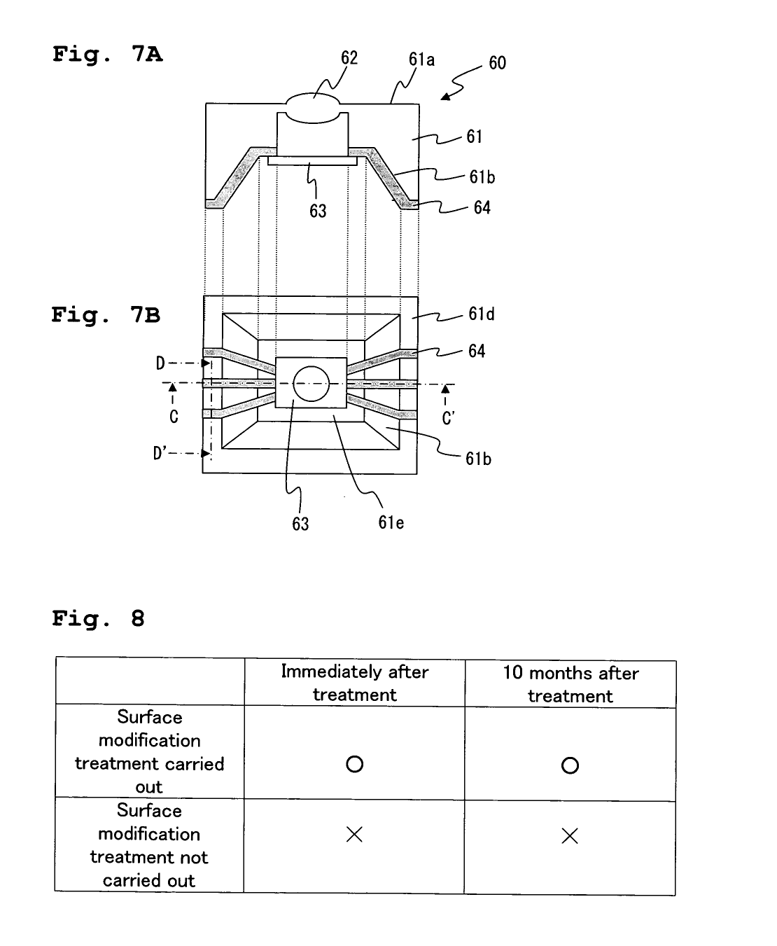

The constitution of the lens module produced in this example is schematically shown in FIGS. 7A and 7B. As shown in FIGS. 7A and 7B, a lens module 60 produced in this example is composed of a polymer substrate 61, a lens 62 and an image sensor 63. One surface 61a (upper surface in FIG. 7A) of the polymer substrate 61 is roughly flat, while the other surface 61b (lower surface in FIG. 7A) is in the form of a three-dimensional surface having a concave shape. As shown in FIG. 7A, the lens 62 is integrally mounted in the polymer substrate 61 in the central portion of the flat surface 61a of the polymer substrate 61, and the image sensor 63 is installed on a bottom 61e of the concave three-dimensional surface 61b. In the lens module 60 of this example, as shown in FIG. 7B, a plurality of three-dimensional wires 64 are formed which connect the top 61d and bottom 61e of the concave three-dimensional surface 61b of the polymer substrate 61. These three-dimensional wires 64 are required for mounting the image sensor on the concave three-dimensional surface 61b of the polymer substrate 61.

A polymer substrate made from amorphous polyolefin having a glass transition temperature Tg of about 145° C. was used for the polymer substrate 61.

The three-dimensional wires 64 were formed of a Cu film. The method for producing the three-dimensional wires 64 is as described below. First, a plating base is formed on the region of the polymer substrate 61 corresponding to a wiring pattern on the concave three-dimensional surface 61b. More specifically, a hexane solution of bis(acetylacetonato) palladium metal complex is applied to the wiring pattern region on the concave three-dimensional surface 61b of the polymer substrate 61 by ink jet printing. Next, a supercritical carbon dioxide makes contact with the polymer substrate 61 in the similar manner as Example 2 to permeate and stabilize the metal complex applied to the wiring pattern region of the concave three-dimensional surface 61b within the polymer substrate 61. Furthermore, examples of metal complexes able to be used which are capable of dissolving in the supercritical carbon dioxide, being reduced and serving as a plated core include platinum dimethyl(cyclooctadiene), bis(cyclopentadienyl)nickel, bis(acetylacetonato)palladium and the like.

Subsequently, the polymer substrate 61 was immersed in a reducing agent (sodium borohydride) to reduce the metal complex and obtain metal fine particles. A plating base was formed at the region corresponding to the wiring pattern on the concave three-dimensional surface 61b of the polymer substrate 61 in this manner.

Next, Cu was plated onto concave three-dimensional surface 61b of the polymer substrate 61 by electroless plating. At this time, the Cu film grows only at the region where the surface was modified by permeation of the metal complex (region of the plating base). In this example, the Cu film having a thickness of 10 μm was formed. The three-dimensional wires 64 composed of the Cu film were formed on the three-dimensional surface 61b of the polymer substrate 61 in this manner as shown in FIGS. 7A and 7B. As described above, in the case the polymer substrate to which the surface modification method of the present invention is applied has a three-dimensional structure as in this example, a permeating substance can be applied to the three-dimensional portion (concave-convex portion) by carrying out pattern printing by ink jet printing. Therefore, the use of the surface modification method of the present invention made it possible to carry out wiring to a three-dimensional portion which was not possible in the prior art.

Next, the adhesion of the three-dimensional wires 64 of the lens module 60 produced in this example was evaluated. More specifically, a peeling test by using adhesive tape was carried out for the three-dimensional wires 64 formed on the three-dimensional surface 61b of polymer substrate 61. Furthermore, a lens module in which surface modification treatment (treatment consisting of bringing into contact with the supercritical carbon dioxide to permeate a metal complex) was not carried out for the three-dimensional surface 61b of the polymer substrate 61 was produced for comparison purposes (to be referred to as the lens module of Comparative Example 3), and the adhesion thereof was evaluated. Those results are shown in FIG. 8. As is clear from FIG. 8, in the lens module of Comparative Example 3 (Surface modification treatment not carried out in FIG. 8), the three-dimensional wires were easily peeled in the peeling test. In contrast, in the lens module 60 of this example (Surface modification treatment carried out in FIG. 8), the three-dimensional wires 64 were resistant to peeling, and it was found out that the adhesion had been improved considerably. Moreover, the adhesion of the three-dimensional wires 64 was confirmed after allowing the lens module to stand in the air for 10 months after the surface modification treatment. As a result, it was found out that they were resistant to peeling and satisfactory adhesion was maintained.

### EXAMPLE 5

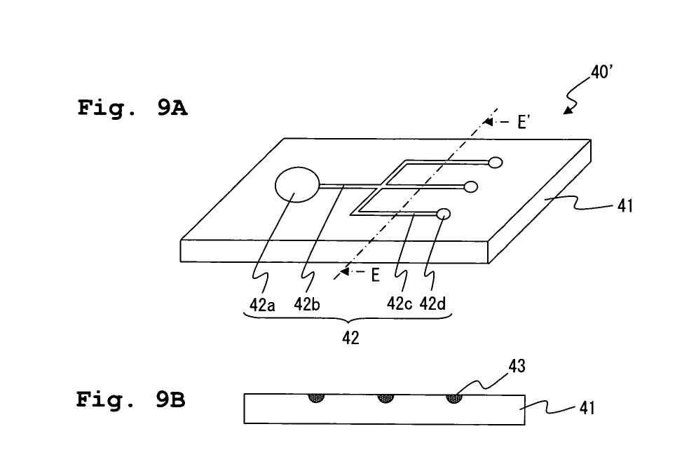

In Example 5, similarly as in Example 2, an example is explained in which the surface modification method of the present invention is applied to a plate used for biochemical analysis and so on referred to as micro TAS (μ-TAS). However, a surface modification method that differs from that of Example 2 is explained. The constitution of the micro TAS produced in this example is schematically shown in FIGS. 9A and 9B.

In a micro TAS 40′ of this example, the pattern 42 of the permeating substance 43 was formed on the polymer substrate 41 as shown in FIG. 9A. Furthermore, in this example, the same substrate as the polymer substrate used in Example 2 was used for the polymer substrate 41 (polymer substrate), and the shape and dimensions of the pattern 42 of the permeating substance 43 were the same as in Example 2. In addition, PEG was used for the permeating substance 43 in the similar manner as in Example 2. Furthermore, in this example, since the PEG 43 that did not permeate into the polymer substrate 41 was removed as will be described later, the micro TAS 40′ of this example differs from that of Example 2 (FIG. 5B) and becomes in state that nearly all of the PEG 43 had permeated into the polymer substrate 41 as shown in FIG. 9B. The pattern 42 of the PEG 43 was formed on the polymer substrate 41 in the manner described below.

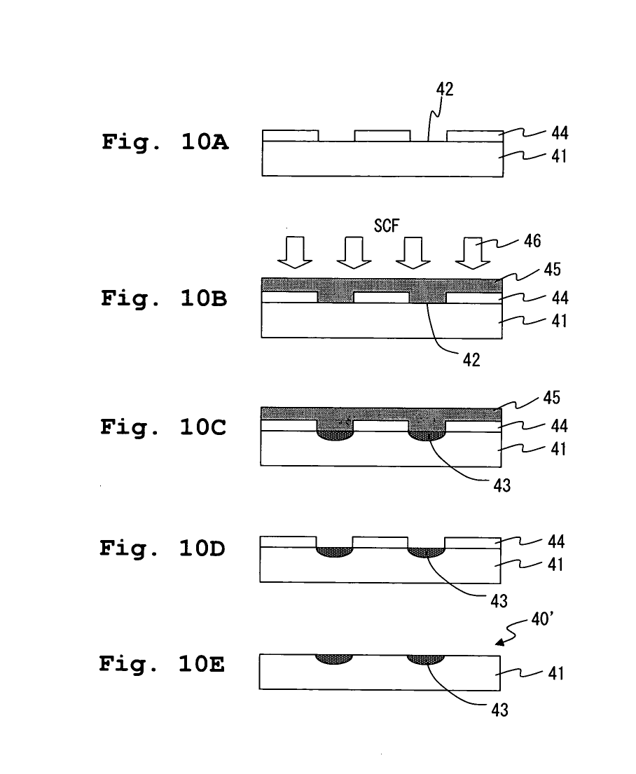

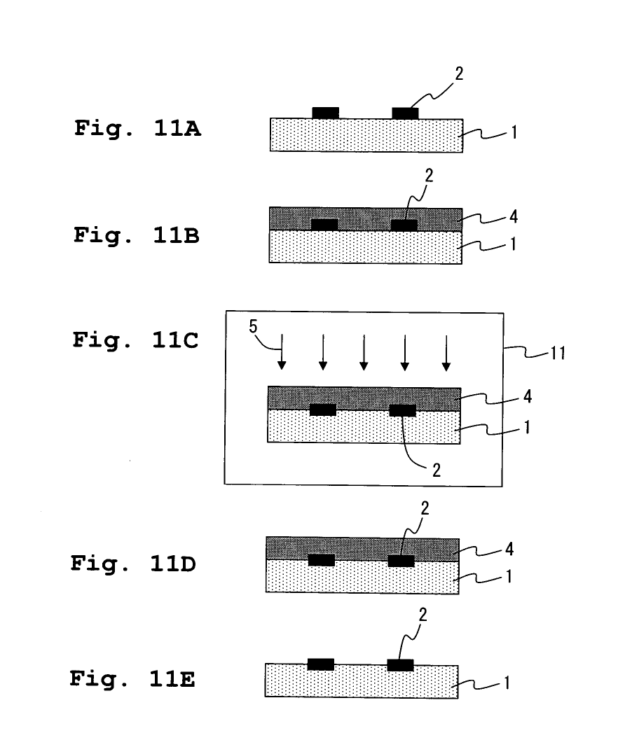

The method for producing the micro TAS of this example is explained with reference to FIGS. 10A to 10E. Furthermore, the same high-pressure device (FIG. 3) as that used in Example 1 was used for the high-pressure device used in the surface modification method of this example.

First, as shown in FIG. 10A, a mask layer 44 having an opening for the pattern 42 of the PEG 43 was formed on the polymer substrate 41. Next, a layer 45 of the PEG 43 which permeates into the polymer substrate 41 was formed on the mask layer 44. More specifically, the PEG 43 (average molecular weight: 1000) heated to 60° C. was coated onto the mask layer 44 and an opening 42 in the mask layer 44 as shown in FIG. 10B. Furthermore, although this example explains an example of having coated the PEG layer 45 over the entire surface of the mask layer 44 as shown in FIG. 10B, the present invention is not limited thereto. In the surface modification method of this example, although the PEG 43 is required to be coated on the opening 42 in the mask layer 44, the PEG 43 is not required to be coated at other regions on the mask layer 44.

Next, the polymer substrate 41 on which the layer 45 of the PEG 43 has been formed was placed in the recess 31 of the high-pressure container 11 used in Example 1, and the inside of the high-pressure container 11 was sealed. Next, the supercritical carbon dioxide 46 having a pressure P1 of 15 MPa and temperature of 50° C. was introduced and retained in the high-pressure container 11 (state shown in FIG. 10B). After the pressure of the supercritical carbon dioxide had stabilized, that state was maintained for 30 minutes. At this time, by bringing the supercritical carbon dioxide into contact with the surface of the polymer substrate 41, a portion of the PEG layer 45 formed on the opening 42 of the mask layer 44 permeated from the surface of the polymer substrate 41 exposed in the opening of the mask layer 44 into the polymer substrate 41 together with the supercritical carbon dioxide (state shown in FIG. 10C). Namely, in this example, PEG is permeated into a polymer substrate by preliminarily coating PEG on the polymer substrate and then contacting with the supercritical carbon dioxide from above.

In addition, although the supercritical carbon dioxide makes contact with the region other than the opening in the mask layer when the supercritical carbon dioxide makes contacted with the polymer substrate, since the mask layer is formed at this region, PEG does not permeate into the polymer substrate 41 at this region (the surface of the polymer substrate 41 is not modified at this region).

Next, after the PEG 43 has permeated into the predetermined region of the polymer substrate 41, the inside of the high-pressure container 11 was opened to the atmosphere, and the polymer substrate 41 was taken out from the high-pressure container 11 (state shown in FIG. 10C). Next, the PEG 43 (PEG layer 45) which had not permeated into the polymer substrate 41 was removed by washing with water or an alcohol such as ethyl alcohol (state shown in FIG. 10D). Next, the mask layer 44 was removed with an exclusive removal solution (state shown in FIG. 10E). In this manner, a micro TAS 40′ (polymer member) made from polymethyl methacrylate resin was able to be obtained in which the PEG 43 had permeated into the surface of the polymer substrate 41 only at the region of the pattern 42, namely, the surface modification had been carried out only at the region to which the PEG 43 had been applied. In the micro TAS 40′ produced in this example, only the surface of the polymer substrate 41 into which the PEG 43 had permeated (the pattern 42 region) was hydrophilized.

Next, the wettability of the surface of the micro TAS 40′ of this example produced in the manner described above was evaluated. Furthermore, a micro TAS in which a PEG pattern was only printed by ink jet printing on a polymer substrate (treatment permeating PEG into a polymer substrate with a supercritical fluid was not carried out) was also produced (to be referred to as micro TAS of Comparative Example 4) for comparison purposes, and the wettability thereof was also evaluated. As a result, in the micro TAS of Comparative Example 4, in contrast to the contact angle of water at the region of the surface to which PEG was applied being about 55°, in the micro TAS 40′ of this example (micro TAS which performed the surface modification treatment), the contact angle of water at the surface to which PEG was applied was about 10°. Namely, as a result of carrying out the surface modification treatment bringing into contact with the supercritical carbon dioxide as the micro TAS 40′ produced in this example, it was found out that the wettability of the region to which the PEG had been applied had been improved considerably (improved hydrophilicity). In addition, when water droplets were dropped onto the micro TAS 40′ produced in this example in the vicinity of the circular portion 42a formed therein, it was confirmed that the water moved along the channel 42b and the branching channels 42c, and reached the small circular portions 42d.

In addition, the wettability of the micro TAS 40′ of this example was again confirmed after immersing in water for 24 hours. As a result, there was hardly any change in the water contact angle. Moreover, after allowing the micro TAS 40′ of this example to stand in air for 10 months, the wettability of the region to which the PEG was applied was confirmed. As a result, the water contact angle was found to be 13°, thus it was found out that satisfactory wettability was maintained. It is conceived that this is because the wettability is stably maintained due to the permeation of a high concentration of the PEG into the polymer substrate.

### EXAMPLE 6

In Example 6, similarly as in Example 1, an explanation is provided of a method for carrying out surface modification by applying a dye 2 (permeating substance) to the surface of a polymer substrate 1 in a character pattern (“A” and “B”), and only allowing the dye 2 to permeate into the polymer substrate 1 only at that region as shown in FIG. 2. However, this example explains a surface modification method that differs from Example 1. Furthermore, the same high-pressure device as used in Example 1 (FIG. 3) was used for the high-pressure device used in the surface modification method of this example.

### Surface Modification Method for Polymer Substrate

The following provides an explanation of the method for modifying the surface of a polymer substrate of this example with reference to FIGS. 11A to 11E. First, a polymer substrate 1 having a flat surface was preliminarily prepared. Polycarbonate resin having a glass transition temperature Tg of about 130° C. was used for the polymer substrate 1. Next, a dye 2 was applied to the surface of this polymer substrate 1 in a predetermined pattern (character pattern consisting of the alphabet characters “A” and “B”) by screen printing. Furthermore, the same alcohol solution of the dye, Blue 35, used in Example 1 (see the previously indicated Chemical Formula 1) was used for the dye 2 applied to the polymer substrate 1. Furthermore, at this time, the dye 2 was applied so that the coated thickness of the dye solution was about 15 μm. Next, the polymer substrate 1 coated with the dye 2 was dried for 1 hour at 70° C., followed by cooling for 1 hour at room temperature. In this manner, the polymer substrate 1 was obtained in which the dye 2 was applied in a predetermined character pattern to the surface thereof as shown in FIG. 2. A schematic cross-sectional view of the polymer substrate 1 at this time is shown in FIG. 11A. At this time, the dye 2 is only coated on the polymer substrate 1, and has not permeated therein.

Next, a coating layer 4 was formed on the polymer substrate 1 so as to cover the dye 2 formed in a character pattern (state shown in FIG. 11B). More specifically, the coating layer 4 was formed in the manner described below. Furthermore, in this example, polyvinyl alcohol was used for the material which forms the coating layer 4. First, polyvinyl alcohol was coated over the entire surface of the side of the polymer substrate 1 to which the dye 2 was applied by spin coating. At this time, the coated thickness was made to be about 100 μm. Next, the polymer substrate 1 coated with the polyvinyl alcohol was dried for 1 hour at 70° C. and then cooled for 1 hour at room temperature. The coating layer 4 was formed on the polymer substrate 1 in this manner. Furthermore, at this time as well, since the dye 2 applied to the polymer substrate 1 is in the state of being only covered by the coating layer 4, the dye 2 has not permeated into the polymer substrate 1.

Next, after the polymer substrate 1 was placed in the bottom of the recess 31 of the high-pressure container 11, the supercritical carbon dioxide 5 made contact with the polymer substrate 1 in the similar manner as Example 1 (state shown in FIG. 11C). At this time, when the supercritical carbon dioxide 5, which was introduced into the recess 31 of the high-pressure container 11, makes contact with the polymer substrate 1 from the side of the coating layer 4 of the polymer substrate 1, the supercritical carbon dioxide 5 first permeates into the coating layer 4. Next, the supercritical carbon dioxide 5 reaches the dye 2 covered by the coating layer 4, and the dye 2 dissolves in the supercritical carbon dioxide 5. The dye 2, which has dissolved in the supercritical carbon dioxide 5, then permeates into the polymer substrate 1 together with the supercritical carbon dioxide 5. At this time, although the dye 2 is in a fluid state dissolved in the supercritical carbon dioxide 5, since the dye 2 is covered by the coating layer 4, diffusion of the dye 2 to the outside from the surface of the polymer substrate 1 can be inhibited. As a result, the dye 2 can be permeated into the polymer substrate 1 efficiently and at a high concentration as compared with the case of not forming the coating layer 4. In addition, in the case of forming the coating layer 4 so as to cover the dye 2 applied in a predetermined pattern to the polymer substrate 1 as in the present example, since diffusion of the dye 2 in the plane direction of the polymer substrate 1 can be inhibited, bleeding of the pattern of the dye 2 is inhibited. Therefore, a finer pattern can be formed with high precision as compared with the case of not forming the coating layer 4.

Next, the polymer substrate 1 was taken out in the similar manner as Example 1 (state shown in FIG. 11D). Next, the coating layer 4 is removed by rinsing the polymer substrate 1 with water, and any dye 2 remaining on the surface of the polymer substrate 1 is removed by washing the polymer substrate 1 with isopropyl alcohol (state shown in FIG. 11E).

As a result of the above-mentioned process, the polymer substrate 1 (polymer member) is obtained in the state in which the character pattern of the dye 2 has permeated into the polymer substrate 1 as shown in FIG. 1. Namely, the polymer substrate 1 which is composed of a polycarbonate resin and on which surface modification has been partially carried out with the dye 2, is obtained.

### COMPARATIVE EXAMPLE 5

In Comparative example 5, a polymer substrate (to be referred to as the polymer substrate of Comparative Example 5) was produced by adding a dye 2 to a polymer substrate 1 by screen printing but without forming a coating layer and carrying out the above-mentioned surface modification treatment (treatment for bringing into contact the polymer substrate 1 with a supercritical fluid to cause the dye 2 to permeate into the polymer substrate 1). Furthermore, the same materials used in Example 6 were used for the polymer substrate 1 and the dye 2.

### Evaluation of Adhesion

The adhesion of the dye 2 formed on the surface of the polymer substrate 1 obtained in the above-mentioned Example 6 and Comparative Example 5 was evaluated. More specifically, the adhesion was evaluated by immersing the polymer substrate 1 in isopropyl alcohol, which is a good solvent of the coloring material (dye). As a result, the dye eluted and the printing disappeared when the polymer substrate of Comparative Example 5 was immersed in the isopropyl alcohol. However, there was no loss of color observed in the printed region (character pattern region) of the polymer substrate 1 produced in Example 6. This is thought to be due to the fact that, in the polymer substrate of Comparative Example 5, the dye did not permeate into the polymer substrate, thereby making it to be susceptible to elution, in contrast, in Example 6, the dye 2 permeated into the polymer substrate 1 at a high concentration, thereby making it resistant to elution, as a result of having carried out the above-mentioned surface modification treatment (treatment bringing into contact with a supercritical fluid to cause the dye 2 to permeate into the polymer substrate 1).

### Cross-Sectional Structure

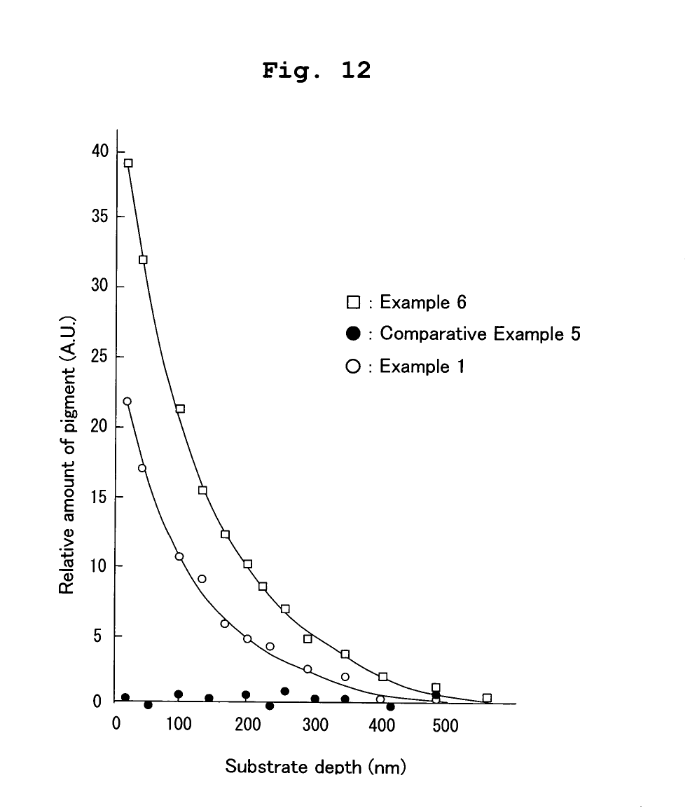

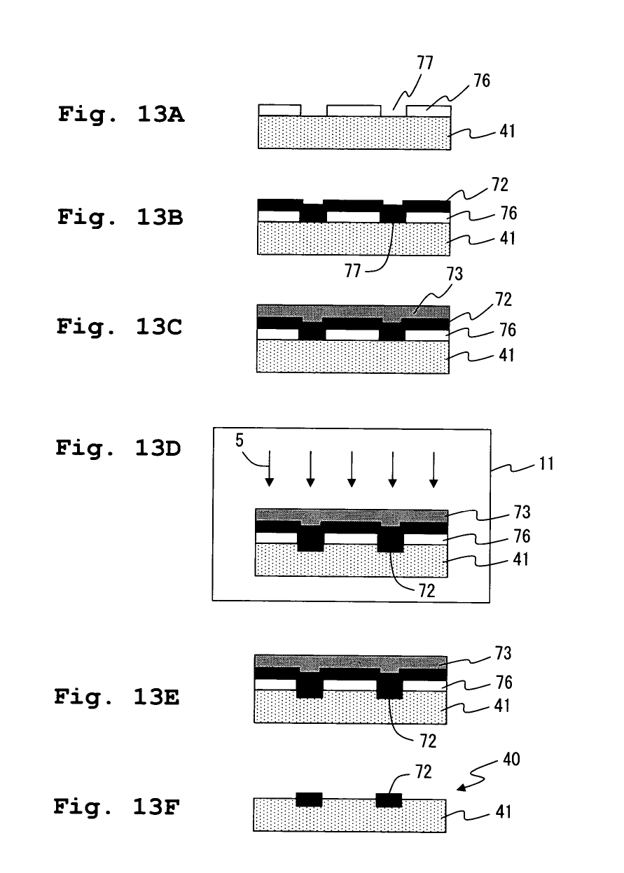

The state of the-permeation of the permeating substance (dye) into the surface of the polymer substrate was analyzed for the polymer substrates produced in Example 6 and Comparative Example 5 in the similar manner as Example 1. Those results are shown in FIG. 12. In FIG. 12, the location of depth in the direction of thickness of the polymer substrate is represented on the horizontal axis, while the relative value of dye content is represented on the vertical axis with an arbitrary scale. Furthermore, the analysis results for the polymer substrate produced in Example 1 are also shown for comparison purposes in FIG. 12. The white squares in FIG. 12 represent the measured results for Example 6, the black circles represent the measured results for Comparative Example 5, and the white circles represent the measured results for Example 1. In addition, the Oposition on the horizontal axis indicates the uppermost surface of the polymer substrate. Namely, in the characteristics of FIG. 12, the location of depth of the substrate becomes deeper toward the right side in the graph. As is clear from FIG. 12, in the polymer substrate produced in Example 6, it was found out that the dye had permeated to a depth of about 500 nm from the vicinity of the uppermost surface of the polymer substrate. On the other hand, in the polymer substrate produced in Comparative Example 5, the dye was observed to have hardly permeated into the polymer substrate at all as is clear from FIG. 12. In addition, in the polymer substrate produced in Example 1, although the dye permeated to a depth of about 400 nm from the vicinity of the uppermost surface of the polymer substrate, the amount of permeated dye was about 60% that of the case of Example 6. Namely, based on a comparison of the permeated amounts of the dye between Example 6 and Example 1 shown in FIG. 12, it was found that as a result of the dye being covered with a coating layer as in Example 6, the dye permeated deeper in the polymer substrate and at a higher concentration. This is because by covering of the dye with the coating layer, the diffusion of the dye to the outside during contact with the supercritical fluid is inhibited, thereby enabling the dye to permeate more efficiently into the polymer substrate.

### Evaluation of Pattern Bleeding

Moreover, the degree of bleeding of the dye patterns (character patterns) formed on the surfaces of the polymer substrates produced in Example 6, Example 1 and Comparative Example 5 was evaluated by visual observation. As a result, although bleeding was not observed in the polymer substrate 1 of Example 6, bleeding was observed in the polymer substrate of Example 1. On the basis of this result, it was found out that covering the dye with a coating layer as in Example 6 inhibited diffusion of the dye in a direction within the plane of the polymer substrate 1 during contact with the supercritical fluid, thereby making it possible to inhibit bleeding of the dye pattern. Namely, by covering the dye with a coating layer as in Example 6, it was found out that a high-definition dye pattern can be formed on the polymer substrate with little bleeding. Furthermore, since surface modification treatment with a supercritical fluid was not carried out in Comparative Example 5, the dye remained in the state after the dye had been applied by screen printing, and bleeding was naturally not observed.

### EXAMPLE 7

In Example 7, similarly as in Example 2, an example is explained in which the surface modification method of the present invention is applied to a plate used for biochemical analysis and so on referred to as micro TAS. However, in this example, a surface modification method was carried out by at method that differs from that of Example 2.

The structure of the micro TAS produced in this example was the same as that of Example 2 (FIGS. 5A and 5B). Namely, a polymer substrate made of polymethyl methacrylate resin and having a glass transition temperature Tg of about 100° C. (Asahi Chemical Industries, trade name: Delpet 560F) was used for the polymer substrate 41, and polyethylene glycol (PEG) having an average molecular weight of about 1000 was used for the permeating substance 43 which forms the pattern 42. In addition, the pattern 42 of the PEG 43 was the same as that of Example 2. In addition, the same high-pressure device (FIG. 3) as that used in Example 1 was used for the high-pressure device used in the surface modification method of this example.

In this example, the PEG 43 was first applied in a predetermined pattern (the pattern 42) on the polymer substrate 41 by screen printing. At this time, the PEG 43 softened by heating to 60° C. was applied to the surface of the polymer substrate 41 by screen printing. A predetermined pattern 42 of the PEG 43 was formed on the surface of the polymer substrate 41 in the manner described above.

Next, polyvinyl alcohol was coated by screen printing on the polymer substrate 41 so as to cover the PEG 43 printed in the pattern 42 and dried to form a coating layer on the PEG 43. Furthermore, at this time, since a predetermined pattern 42 of the PEG 43 was formed on the polymer substrate 41 and this PEG 43 was only covered with a coating layer (state shown in, for example, FIG. 11B), the PEG 43 does not permeate into the polymer substrate 41.

Next, after placing the polymer substrate 41, on which the pattern 42 of the PEG 43 was formed by screen printing followed by formation of a coating layer thereon, in the recess 31 of the high-pressure container 11 used in Example 1, the supercritical carbon dioxide 5 made contact with the polymer substrate 41 in the similar manner as Example 1. Furthermore, the supercritical carbon dioxide having a pressure P of 15 MPa and temperature of 50° C. was introduced and retained in the high-pressure container 11. After the pressure P of the supercritical carbon dioxide had stabilized, that state was maintained for 30 minutes. As a result of this process, the PEG 43 permeated into the polymer substrate 41 together with the supercritical carbon dioxide. At this time, although the PEG 43 is in a fluid state dissolved the supercritical carbon dioxide, since the PEG 43 is covered by the coating layer, diffusion of the PEG 43 to the outside from the surface of the polymer substrate 41 can be inhibited. As a result, the PEG 43 can be permeated into the polymer substrate 41 efficiently and at a high concentration as compared with the case of not forming a coating layer. In addition, in the case of having formed a coating layer so as to cover the PEG 43 which has been applied in a predetermined pattern to the polymer substrate 41 as in the present example, since diffusion of the PEG 43 in the plane direction of the polymer substrate 41 can be inhibited, bleeding of the pattern of the PEG 43 is inhibited. Therefore, a finer pattern can be formed with higher definition as compared with the case of not forming a coating layer.

Next, the polymer substrate 41 was taken out from the high-pressure container 11 in the similar manner as Example 1. Subsequently, the coating layer was removed by rinsing the polymer substrate 41 with water. In this manner, the micro TAS 40 (polymer member) made from polymethylmethacrylate resin was able to be obtained in which the PEG 43 had permeated only into the pattern 42 region of the surface of the polymer substrate 41, namely had been subjected to surface modification only at the portion to which the PEG 43 had been applied. In the micro TAS 40 produced in this example, only the surface of the polymer substrate 41 into which the PEG 43 had permeated (the pattern 42 region) was hydrophilized.

### COMPARATIVE EXAMPLE 6

In Comparative Example 6, a micro TAS (to be referred to as the micro TAS of Comparative Example 6) was produced by adding PEG (permeating substance) to a polymer substrate by screen printing but without forming a coating layer and carrying out the above-mentioned surface modification treatment (treatment bringing into contact with a supercritical fluid to cause the PEG to permeate into the polymer substrate). Furthermore, the same materials used in Example 7 were used for the polymer substrate and the PEG.

### Evaluation of Wettability

The wettability (degree of hydrophilization) of the surface of the micro TAS 40 of Example 7 and Comparative Example 6 produced in the manner described above was evaluated. As a result, in the micro TAS of Comparative Example 6, in contrast to the contact angle of water at the region of the surface to which PEG was applied being about 55°, in the micro TAS 40 of Example 7 (the micro TAS which performed surface modification treatment), the contact angle of water at the surface to which PEG was applied was about 10°. Furthermore, the contact angle of Comparative Example 6 was nearly equal to the value for the polymer substrate itself. This indicates that the PEG dissolved in water when water made contact with the PEG formed on the polymer substrate of Comparative Example 6, and it is found out that the PEG pattern does not function as a channel.

On the basis of these results, it was found out that the wettability of a region to which PEG has been applied is improved considerably (improved hydrophilicity) by carrying out surface modification treatment (bringing into contact with supercritical carbon dioxide) as in the micro TAS 40 produced in Example 7.

In addition, when the wettability of the micro TAS 40 of Example 7 was again confirmed after immersing in water for 24 hours, there was hardly any change in the water contact angle. Moreover, after allowing the micro TAS 40 of Example 7 to stand in air for 10 months, when the wettability of the region to which the PEG was applied was confirmed, the water contact angle was found to be 13°. Therefore, it was found out that satisfactory wettability was maintained. It is conceived that this is because the wettability is stably maintained due to the permeation of a high concentration of PEG into the polymer substrate.

### Evaluation of Channel Pattern

A small amount of water was dropped onto the surface of the micro TAS produced in Example 7, Example 2 and Comparative Example 6 to evaluate the degree of bleeding of the formed channel patterns by visual observation. As a result, although bleeding was not observed in the micro TAS of Example 7, bleeding was observed in the micro TAS of Example 2. On the basis of this result, it was found out that covering the channel pattern formed by PEG with a coating layer as in Example 7 inhibited diffusion of PEG in a plane direction of the polymer substrate during contact with the supercritical fluid, thereby making it possible to inhibit bleeding of the channel pattern. Namely, as a result of covering the PEG by a coating layer as in Example 7, it was found out that a high-definition PEG channel pattern can be formed on the polymer substrate with little bleeding. Furthermore, since surface modification treatment with a supercritical fluid was not carried out in Comparative Example 6, the PEG remained in the state after the PEG had been applied by screen printing, and as such, bleeding was naturally not observed when water was dropped thereon. However, as time passed, bleeding of the channel occurred due to the PEG dissolving in the water. Moreover, this bleeding became more extensive with the passage of time.

In addition, water droplets were dropped onto the vicinity of the circular portion formed in the micro TAS to observe the state in which the water moved through the channels in the micro TAS of Example 7, Example 2 and Comparative Example 6. When water droplets were dropped onto the vicinity of the circular portion 42a formed on the micro TAS 40 produced in Example 7, it was confirmed that the water moved along the channel 42b and the branching channels 42c and finally reached the small circular portions 42d. On the other hand, in the micro TAS of Comparative Example 6, the water droplets did not move along the channels. In addition, in the micro TAS of Example 2, although it was observed that the water droplets moved along the channels formed with PEG, the flow of the water droplets was not as smooth as in Example 7, and it was found out that the propagation time of the water droplets was long. It is conceived that this is because the irregularities is formed in the lateral surfaces of the channels due tithe occurrence of bleeding of the PEG in the channel pattern, and obstructs the propagation of the water droplets in the micro TAS of Example 2. Namely, on the basis of these results, it was found out that carrying out surface modification treatment after having covered a channel pattern formed with PEG by a coating layer as in the micro TAS of Example 7 inhibited bleeding of the channel pattern and enable the formation of a channel pattern that facilitated the flow of liquid.

### EXAMPLE 8

In Example 8, similarly as in Example 7, an example is explained in which the surface modification method of the present invention is applied to a micro TAS. However, in this example, a surface modification method is explained which is preferable in the case of forming a finer permeating substance pattern on a polymer substrate than that in Example 7. The structure and materials used to form the micro TAS produced in this example were the same as in Example 3 (FIGS. 6A and 6B). The micro TAS 50 of this example was produced in the manner described below.

First, a metal mold, in which a concave-convex pattern opposite that of a groove pattern 52 formed in the polymer substrate 51 was formed, was preliminarily prepared, and the polymer substrate 51, in which the groove pattern 52 was formed in the surface thereof as shown in FIGS. 6A and 6B, was produced by injection molding by using this metal mold. Furthermore, in this example, although the concave-convex pattern in the metal mold was formed by precision machining, a concave-convex pattern may also be formed in the metal mold by applying lithography.

Next, as shown in FIG. 6A, PEG 53 was applied along the groove pattern 52 of the polymer substrate 51 formed by the above-mentioned method by ink jet printing. At this time, the PEG 53, which was in a softened state by being heated to 60° C., was discharged from an ink jet head and applied within the groove pattern 52 formed in the surface of the polymer substrate 51. Furthermore, in the case the PEG 53 protruded from the groove pattern 52 in this step, the unnecessary PEG 53 is preferably removed by wiping with water or alcohol.

Next, polyvinyl alcohol was coated on the polymer substrate 51 so as to cover the PEG 53 applied to the groove pattern 52 and dried to form a coating layer on the PEG 53. Next, the supercritical carbon dioxide made contact with the surface of the polymer substrate 51 in the similar manner as in Example 7 to modify the surface of the polymer substrate 51 by causing the PEG 53 to permeate into the groove pattern 52 of the polymer substrate 51 (hydrophilization). The micro TAS 50 (polymer member) of this example was obtained in this manner.

In the micro TAS 50 of this example, since the lateral and upper surfaces of PEG 53 applied into the groove pattern 52 are surrounded (in a state of being covered) by the sidewalls of the groove pattern 52 and the coating layer, respectively, diffusion of the PEG 53 to the outside from the groove pattern 52 can be inhibited, and the PEG 53 is able to permeate into the polymer substrate 51 efficiently and at a high concentration. In addition, when a micro TAS is produced by the method described above, a permeating substance can be applied onto a polymer substrate in a pattern of 100 μm or less, there by making it possible to produce a micro TAS in which only the region of the fine pattern is modified.

In addition, the wettability of the micro TAS 50 produced in this example was evaluated in the similar manner as Example 7. As a result, the similar results as Example 7 were obtained. Namely, the wettability was improved only at the pattern region into which PEG had permeated, the region became hydrophilic and that hydrophilicity was confirmed to be stably maintained.

### EXAMPLE 9

In Example 9, similarly as in Example 4, an example is explained in which the method for modifying the surface of a polymer substrate of the present invention is applied to polymer surface having a three-dimensional surface. More specifically, in this example, an example is explained in which the method for modifying the surface of a polymer substrate of the present invention is applied similarly as in Example 4 to a module substrate of a single-chip lens module which integrates a lens with an image sensor which detects images formed by the lens in the form of electrical signals. However, in this example, surface modification was carried out by using a different method from that of Example 4.

In addition, the structure and materials used to form the lens module produced in this example were the same as in Example 4 (FIGS. 7A and 7B). Namely, as shown in FIGS. 7A and 7B, the three-dimensional wires 64 were formed with a Cu film on a concave three-dimensional surface 61b of a polymer substrate 61 made from amorphous polyolefin having a glass transition temperature Tg of about 145° C. The method used to produce the three-dimensional wires 64 of this example is as described below. First, a plating base is formed on the region of the polymer substrate 61 corresponding to a wiring pattern on the concave three-dimensional surface 61b. More specifically, a hexane solution of bis(acetylacetonato)palladium metal complex (permeating substance) is applied to the wiring pattern region on the concave three-dimensional surface 61b of the polymer substrate 61 by ink jet printing.

Next, polyvinyl alcohol is coated on the three-dimensional surface 61b of the polymer substrate 61 so as to cover the wiring pattern region to which the bis(acetylacetonato)palladium metal complex had been applied, and dried. Furthermore, in this example, the polyvinyl alcohol was coated by spray coating. As a result, a coating layer was formed on the wiring pattern region.

Next, the supercritical carbon dioxide makes contact with the polymer substrate 61 in the similar manner as Example 7 to permeate and stabilize in the polymer substrate 61 the metal complex applied to the wiring pattern region of the concave three-dimensional surface 61b. In the case of having permeated a metal complex into the polymer substrate 61 in the manner described above, since the metal complex applied to the wiring pattern region permeates into the polymer substrate 61 together with the supercritical carbon dioxide in the state of being covered by the coating layer, diffusion of the metal complex to outside of the wiring pattern region can be inhibited, and the metal complex is able to permeate into the polymer substrate 61 efficiently and at a high concentration, and a high-definition wiring pattern is able to form without bleeding. Furthermore, examples of metal complexes which are capable of dissolving in the supercritical carbon dioxide, being reduced and serving as a plated core include platinum dimethyl(cyclooctadiene), bis(cyclopentadienyl)nickel, bis(acetylacetonato)palladium, hexafluoroacetylacetonato palladium or the like.

After the metal complex had permeated into the polymer substrate 61, the coating layer formed with polyvinyl alcohol was removed by rinsing the polymer substrate 61 with water, and then any metal complex remaining on the polymer substrate 61 was removed by washing the polymer substrate 61 with ethanol. Then, the polymer substrate 61 was immersed in a reducing agent (sodium borohydride) to reduce the metal complex and obtain metal fine particles. A plating base was formed at the region corresponding to the wiring pattern on the concave three-dimensional surface 61b of the polymer substrate 61 in this manner.

Next, the side of the polymer substrate 61 having the concave three-dimensional surface 61b was plated with Cu by electroless plating. At this time, the Cu film grows only at the region where the surface has been modified by permeation of the metal complex (region of the plating base). In this example, the Cu film was formed at a thickness of 10 μm. In this manner, the three-dimensional wires 64 composed of a Cu film were formed on the three-dimensional surface 61b of the polymer substrate 61 as shown in FIGS. 7A and 7B. As described above, in the case a polymer substrate has a three-dimensional structure as in the present example, a permeating substance can be applied to the three-dimensional portion (concave-convex portion) by carrying out pattern printing by ink jet printing. Therefore, the use of the surface modification method of the present invention made it possible to carry out wiring to a three-dimensional portion which was not possible in the prior art.

### COMPARATIVE EXAMPLE 7

In Comparative Example 7, reduction treatment and Cu electroless plating were carried out in state that had applied a metal complex to a region corresponding to the wiring pattern of the three-dimensional surface of a polymer substrate, but without forming a coating layer on the polymer substrate and carrying out the above-mentioned surface modification treatment (treatment bringing into contact with a supercritical fluid to permeate the metal complex into the polymer substrate) (to be referred to as the lens module of Comparative Example 7). However, in Comparative Example 7, a plated film was unable to be formed at the wiring pattern region. It is conceived that this is because a plated film is not formed on a plating base due to poor adhesion between the polymer substrate and plating base since surface modification treatment was not carried out in Comparative Example 7, and the metal complex was only placed on the surface of the polymer substrate without permeating therein.

### Evaluation of Adhesion

Next, the adhesion of the three-dimensional wires of the lens module produced in Example 9 was evaluated. More specifically, a peeling test by using adhesive tape was carried out for the three-dimensional wires formed on the three-dimensional surface of the polymer substrate 61. As a result, the three-dimensional wires were resistant to peeling, and it was found out that adhesion had been improved considerably. Moreover, the adhesion of the three-dimensional wires was confirmed after allowing the lens module to stand in the air for 10 months following surface modification treatment. As a result, it was found out that the tree-dimensional wires were resistant to peeling and satisfactory adhesion was maintained. On the basis of these results, it was found out that three-dimensional wires having satisfactory adhesion can be formed by carrying out treatment in which a supercritical fluid made contact with a polymer substrate to cause a metal complex to permeate into the polymer substrate as in Example 9.

### Evaluation of Wiring Pattern Bleeding

Next, the degree of bleeding of the three-dimensional wiring patterns formed on the surfaces of the lens modules produced in Example 9 and Example 4 was evaluated by visual observation. As a result, although bleeding was not observed in the lens module of Example 9, bleeding was observed in the lens module of Example 4. On the basis of this result, it was found out that covering the wiring pattern region to which a metal complex had been applied with a coating layer as in Example 9 inhibited diffusion of the metal complex in a direction within the plane of the polymer substrate during contact with the supercritical fluid, thereby making it possible to inhibit bleeding of the wiring pattern. Namely, as a result of covering the wiring pattern region to which a metal complex had been applied with a coating layer as in Example 9, it was found out that a high-definition wiring pattern can be formed on the polymer substrate with little bleeding.

### EXAMPLE 10

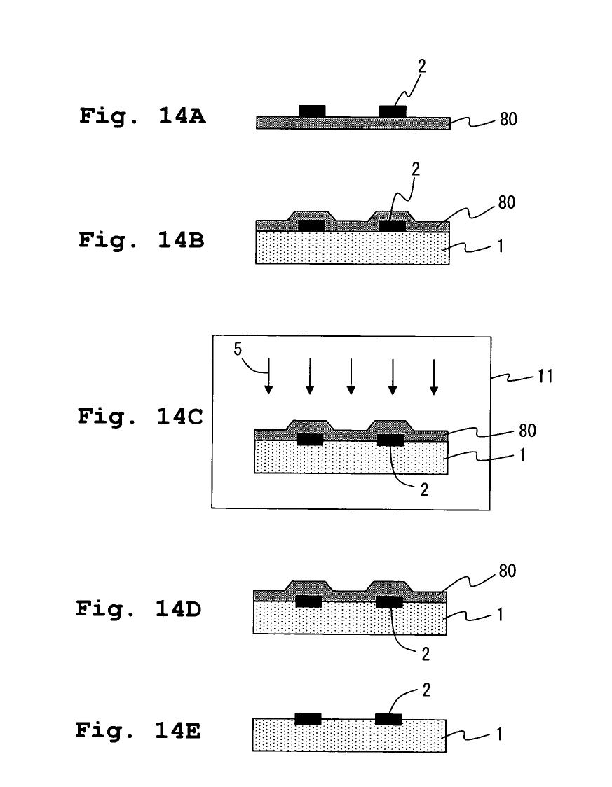

In Example 10, a micro TAS having the similar structure as that of Example 2 (FIGS. 5A and 5B) was produced by a surface modification method which differs from that of Examples 2 and 7. The polymer substrate, permeating substance and pattern formed on the polymer substrate of the micro TAS produced in this example were the same as in Example 2. The surface modification method of the micro TAS of this example is explained with reference to FIGS. 13A to 13F.

First, a mask layer 76 was formed on the polymer substrate 41 in the manner described below. A mask material was adhered to a region other than a pattern region 77 of a channel and so on of PEG (permeating substance) to be formed on the polymer substrate 41 by ink jet printing. In this example, a photosensitive resin (Kayaku Microchem, SU-10) was used for the mask material, and the coated thickness of the photosensitive resin was made to be about 1 μn. Next, the polymer substrate 41 to which the photosensitive resin was adhered was dried for 1 hour at 70° C. followed by cooling for 1 hour at room temperature. Next, the mask material was irradiated with ultraviolet light to cure the mask material and form the mask layer 76. The mask layer 76 having an opening at the pattern region 77 of the PEG 43 was formed on the polymer substrate 41 in this manner (state shown in FIG. 13A). Furthermore, any material can be used for the material of the mask layer 76 provided it is able to block a supercritical fluid and adhere/tightly-adhere to the surface of the polymer substrate 41.

Next, a layer 72 of PEG which permeates into the polymer substrate 41 was formed on the mask layer 76. More specifically, PEG (average molecular weight: 1000) heated to 60° C. was coated onto the mask layer 76 and an opening 77 in the mask layer 76 as shown in FIG. 13B. Furthermore, although this example explains an example of having coated the PEG layer 72 over the entire surface of the mask layer 76 as shown in FIG. 13B, the present invention is not limited thereto. In the surface modification method of this example, although PEG is required to be coated on the opening 77 in the mask layer 76, PEG is not required to be coated at other regions on the mask layer 76.

Next, polyvinyl alcohol was coated so as to cover the PEG layer 72 and dried. At this time, the polyvinyl alcohol was coated at a thickness of 0.5 μm, and the coating layer 73 was formed on the PEG layer 72 (state shown in FIG. 13C). At this time, since the PEG layer 72 was only covered by the mask layer 76 and the coating layer 73, the PEG does not permeate into the polymer substrate 41.

Next, the polymer substrate 41, in which the coating layer 73 was formed on the PEG layer 72, was placed in the recess 31 of the high-pressure container 11 (FIG. 3) used in Example 1, and the inside of the high-pressure container 11 was sealed. Next, the supercritical carbon dioxide 5 having pressure P1 of 15 MPa and temperature of 50° C. was introduced and retained in the high-pressure container 11. After the pressure of the supercritical carbon dioxide 5 had stabilized, that state was maintained for 30 minutes. At this time, by bringing of the supercritical carbon dioxide 5 into contact with the surface of the polymer substrate 41, a portion of the PEG layer 72 formed in the opening 77 of the mask layer 76 permeated from the surface of the polymer substrate 41 exposed in the opening of the mask layer 76 into the polymer substrate 41 together with the supercritical carbon dioxide 5 (state shown in FIG. 13D).

In the micro TAS of this example, since the lateral and upper surfaces of the PEG applied to the polymer substrate 41 are surrounded (in a state of being covered) by the sidewalls of the mask layer 76 and the coating layer 73, respectively, diffusion of PEG to the outside from the polymer substrate 41 can be inhibited, and the PEG is able to permeate into the polymer substrate 41 efficiently and at a high concentration. In addition, in the micro TAS of this example, since the mask layer 76 is formed on the side of the PEG, diffusion of the PEG dissolved in the supercritical fluid in the plane direction of the polymer substrate 41 when the PEG permeates into the polymer substrate 41 can be inhibited, thereby making it possible to inhibit bleeding of the channel patterns of the PEG.

Furthermore, although the supercritical carbon dioxide makes contact with the region other than the opening in the mask layer when the supercritical carbon dioxide makes contact with the polymer substrate (step of FIG. 13D), since the mask layer is formed at this region, PEG does not permeate into the polymer substrate at this region (the surface of the polymer substrate is not modified at this region).

Next, after the PEG has permeated into the predetermined region of the polymer substrate 41, the inside of the high-pressure container 11 was opened to the atmosphere in the similar manner as Example 1, and the polymer substrate 41 was taken out from the high-pressure container 11 (state shown in FIG. 13E). Next, the PEG layer 72 remaining on the polymer substrate 41 and the coating layer 73 was removed by rinsing with water, and mask layer 76 was removed by washing with aqueous solution of sodium hydroxide (state shown in FIG. 13F). In this manner, a micro TAS 40 (polymer member) made from polymethyl methacrylate was able to be obtained in which the PEG permeated only into the pattern 42 on the surface of the polymer substrate 41, namely the surface thereof was modified only at the region to which the PEG was applied. In the micro TAS 40 produced in this example, only the surface (the pattern 42) of the polymer substrate 41 into which the PEG had permeated was hydrophilized similarly as in Example 2.

In addition, the wettability of the micro TAS produced in this example was also evaluated in the similar manner as Example 2. As a result, similar results as in Example 2 were obtained. Namely, it was confirmed that the wettability was improved only in the pattern region into which the PEG had permeated, that region had become hydrophilic, and the wettability was stably maintained. In addition, when water droplets were dropped onto the vicinity of a circular portion 42a formed on the micro TAS produced in this example. As a result, it was confirmed that the water moved along the channel 42b and the branching channels 42c and reached the small circular portions 42d similarly as in Example 7.

### EXAMPLE 11

In Example 11, instead of directly applying a permeating substance to be made to permeate to the polymer substrate as in the above-mentioned Examples 6 to 10, surface modification treatment was carried out by applying a permeating substance in a predetermined pattern on a sheet-like transfer member (to be referred to as a coating film) prepared separate from the polymer substrate, placing the coating film on a polymer substrate, and subsequently causing the permeating substance to permeate into the polymer substrate by bringing the supercritical fluid into contact with the polymer substrate.

In this example, a polymer member (FIG. 2) was produced in which surface treatment was carried out by permeating a dye 2 (permeating substance) in a character pattern (“A” and “B”) into the surface of a polymer substrate 1 similarly as in Example 1. In addition, a polycarbonate resin having glass transition temperature Tg of about 130° C. was used for polymer substrate 1 similarly as in Example 1. The method for modifying the surface of a polymer substrate of this example is explained with reference to FIGS. 14A to 14E.

First, a coating film 80 made from polyvinyl alcohol solidified into the form of a sheet was preliminarily prepared. The thickness of the coating film 80 was 100 μm.

Next, the dye 2, which permeates into the polymer substrate, was applied in a predetermined pattern to the surface of the coating film 80 by ink jet printing. Furthermore, in this example, since a character pattern in the form of alphabet characters “A” and “B” is ultimately formed on the polymer substrate 1 as shown in FIG. 2, when applying the dye 2 to the surface of the coating film 80, the dye 2 was applied to the coating film 80 in the pattern in which the front and back of the above-mentioned character pattern is inverted (to be referred to as an inverted pattern). In addition, an alcohol solution of the dye, Blue 35, represented by the previously described chemical formula (1), was used for the dye 2 applied to the coating film 80 similarly as in Example 1. The dye solution was applied so that the coated thickness was about 15 μm. Next, the coating film 80 on which the dye 2 was coated was adequately dried at room temperature. In this manner, a coating film 80 formed of polyvinyl alcohol was obtained in which the dye 2 was applied in an inverse pattern of a character pattern (state shown in FIG. 14A).

After preparing the coating film 80 to which the dye 2 was applied in the manner described above, the coating film 80 was tightly adhered to the surface of the polymer substrate 1 in the manner described below. When tightly adhering the coating film 80 to the polymer substrate 1, it is effective to interpose water, ethanol methanol or the like between the polymer substrate 1 and the coating film 80. In the present example, a small amount of water was first adhered to the surface of the polymer substrate 1, and then, the coating film 80 was placed thereon. At this time, the side of the coating film 80 on which the dye 2 has been applied was placed so as to oppose the side of the polymer substrate 1 to which the water had been adhered. Next, the surface of the coating film 80 was depressed gradually from the edges of the surface of the coating film 80 while avoiding entrance of air, and the coating film 80 was tightly adhered to the polymer substrate 1, followed by adequately drying at room temperature (state shown in FIG. 14B). Furthermore, at this time, since the coating film 80 to which the dye 2 had been applied was only tightly adhered to the polymer substrate 1, the dye 2 does not permeate into the polymer substrate 1.

Next, the polymer substrate 1 was placed in the high-pressure container 11 used in Example 1, and, in the similar manner as Example 1, the supercritical carbon dioxide 5 made contact with the polymer substrate 1 from the coating film 80 side of the polymer substrate 1 to cause the dye 2 to permeate in a predetermined pattern (character pattern) (state shown in FIG. 14C). In the case of the present example, the supercritical carbon dioxide 5 dissolves the dye 2 applied to the coating film 80 after passing through the coating film 80 and permeates into the polymer substrate 1. At this time, although the dye 2 is in a fluid state dissolved in the supercritical carbon dioxide 5, since the dye 2 is covered by the coating film 80, diffusion of the dye 2 to the outside from the surface of the polymer substrate 1 is inhibited. As a result of this action, a large amount of the dye 2 can be permeated into the polymer substrate 1 efficiently and at a high concentration. In addition, due to the above-mentioned action, bleeding of the pattern of the dye 2 is inhibited. Therefore, a finer pattern can be formed with high definition in this example.

Next, the inside of high-pressure container 11 was opened to the atmosphere in the same manner as Example 1, and the polymer substrate 1 was taken out from the high-pressure container 11 (stage shown in FIG. 14D). Next, the polymer substrate 1 was rinsed with water in the similar manner as Example 6 to remove the coating film 80 (stage shown in FIG. 14E). In this manner, the polymer substrate 1 (polymer member) was obtained in which a character pattern of the dye 2 had permeated into the polymer substrate 1 as shown in FIG. 2. Namely, a polymer substrate made from polycarbonate resin was obtained in which the dye 2 had permeated into the polymer substrate 1 in a predetermined pattern.

When the polymer substrate produced in this present example was evaluated in the similar manner as Example 6, similar results were obtained. Namely, the dye had permeated into the polymer substrate from the surface thereof at a high concentration, and the surface thereof was modified such that the dye was resistant to exfoliation (separation).

As described above, in the method for modifying the surface of a polymer substrate of the present example, since a permeating substance such as a dye, which has been applied to a predetermined portion of the surface of a polymer substrate, is permeated into the polymer substrate in the state of being covered with a coating film, diffusion of the permeating substance into a supercritical fluid can be inhibited. As a result, the permeating substance is able to be permeated into the polymer substrate efficiently and at a high concentration, and the permeating substance can be permeated in a high-definition pattern. Moreover, in the method for modifying the surface of a polymer substrate of the present example, since a coating film (sheet-like transfer member), on which a permeating substance to be permeated into a polymer substrate has been printed in a predetermined pattern, can be prepared separately from the polymer substrate, a coating film to which a permeating substance had been applied in a predetermined pattern can be continuously produced in the form of, for example, a roll-like transfer member. Therefore, in the method for modifying the surface of a polymer substrate of the present example, versatility in manufacturing, such as being able to accommodate various forms of polymer substrates, and low costs can be realized, while also making it possible to improve productivity.

According to the method for modifying the surface of a polymer substrate of the above-mentioned Examples 1 to 11 and a coating member used therein, the surface of a polymer substrate can easily be modified at a predetermined region (region of a predetermined pattern). In particular, since the surface can be easily modified even at a fine region of 100 μm or less, the method for modifying the surface of a polymer substrate of the present invention is particularly suited for the production of the micro TAS and biochips requiring surface modification in a fine pattern, or the production of three-dimensional wiring devices and so on.

### EXAMPLE 12

In Example 12, similarly as in Example 4, an example is explained a method for forming a plated film in a predetermined pattern for a polymer substrate having a three-dimensional surface. More specifically, an example is explained a method for forming a plated film in a predetermined pattern on the three-dimensional surface of module substrate of a single-chip lens module which integrates a lens with an image sensor which detects images formed by the lens in the form of electrical signals similarly as in Example 4. However, in this example, the plated film was formed on the surface of the polymer substrate by using a different method from that of Examples 4 and 9.

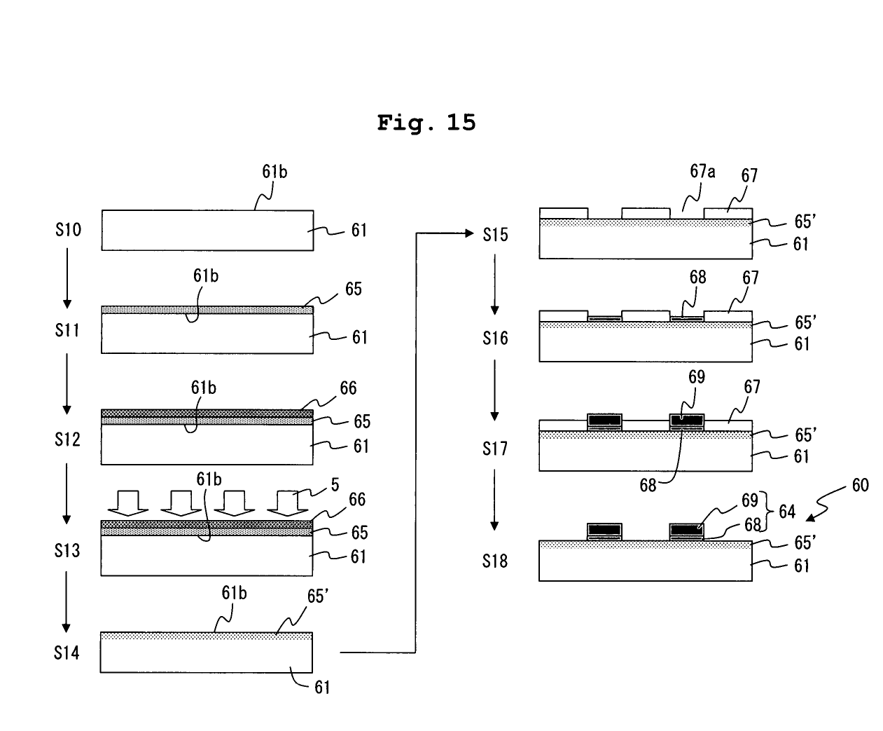

In addition, the structure and materials used to form the lens module produced in this example were the same as in Example 4 (FIGS. 7A and 7B). Namely, as shown in FIGS. 7A and 7B, the three-dimensional wires 64 were formed with a Cu film on a concave three-dimensional surface 61b of a polymer substrate 61 made from amorphous polyolefin having a glass method for producing the three-dimensional wires 64 of this example is shown in FIG. 15. An explanation of a method for forming the plated film of this example is provided with reference to FIG. 15. Furthermore, FIG. 15 shows schematic cross-sectional views of a flat region of a portion of the three-dimensional surface 61b of the polymer substrate 61, for example, schematic drawings of a cross-section taken along line D-D′ in FIG. 7B.

First, a polymer substrate 61 was preliminarily prepared made from amorphous olefin (Step S10 in FIG. 15). Next, a plating base is formed on the surface of the three-dimensional surface 61b of the polymer substrate 61. More specifically, a hexane solution of bis(acetylacetonato) palladium metal complex (permeating substance) 65 was applied to the three-dimensional surface 61b of the polymer substrate 61 by ink jet printing (Step S11 in FIG. 15). Furthermore, in this example, when the metal complex was applied to the three-dimensional surface 61b of the polymer substrate 61, the metal complex was not applied to the entire surface of the three-dimensional surface 61b of the polymer substrate 61. Rather, the metal complex was applied to a partial region (predetermined region), which contains the surface region of the three-dimensional surface 61b of the polymer substrate 61 corresponding to a wiring pattern. However, the present invention is not limited thereto, and the metal complex may also be applied to the entire surface of the three-dimensional surface 61b of the polymer substrate 61.

Next, polyvinyl alcohol was coated on the three-dimensional surface 61b of the polymer substrate 61 so as to cover the metal complex 65 applied to the three-dimensional surface 61b of the polymer substrate 61, and dried. Furthermore, in this example, the polyvinyl alcohol was coated by spraying. As a result, a coating layer 66 was formed on the surface of the polymer substrate (Step S12 in FIG. 15).

Next, the polymer substrate 61 was placed in the high-pressure container 11 of the high-pressure device 100 (FIG. 3) used in Example 1, and the supercritical carbon dioxide 5 made contact with the polymer substrate 61 in the similar manner as Example 1 (Step S13 in FIG. 15). Furthermore, at this time, the supercritical carbon dioxide having a pressure P of 15 MPa and a temperature of 50° C. was introduced and retained in the high-pressure container 11, and after the pressure P of the supercritical carbon dioxide had stabilized, that state was maintained for 30 minutes. As a result of this step, the metal complex 65, which had been applied to a predetermined region on the surface of the three-dimensional surface 61b of the polymer substrate 61 permeated into the polymer substrate 61 and stabilized. In the case of having allowed the metal complex 65 to permeate into the polymer substrate 61 in the manner described above, since the metal complex 65 applied to the surface of the polymer substrate permeates into the polymer substrate 61 together with the supercritical carbon dioxide in the state of being covered by the coating layer, the metal complex 65 is able to permeate into the polymer substrate 61 efficiently and at a high concentration.

After the metal complex 65 has permeated into the polymer substrate 61, the polymer substrate 61 is taken out from the high-pressure device 100 and rinsed with water to remove the coating layer 66 formed of polyvinyl alcohol. Next, the metal complex 65 remaining on the polymer substrate 61 was removed by washing the polymer substrate 61 with ethanol. Next, the polymer substrate 61 was immersed in a reducing agent (sodium borohydride) to reduce the metal complex 65 and obtain metal fine particles 65′ (Step S14 in FIG. 15). In this manner, a plating base (catalyst cores) was formed at a predetermined region on the surface of the three-dimensional surface 61b of the polymer substrate 61.

Next, a mask layer 67, in which a region corresponding to a wiring pattern was an opening 67a, was formed on the surface of the polymer substrate 61 on which the plating base was formed (Step S15 in FIG. 15). AUV curable resin was used for the material which forms the mask layer 67, and the mask layer 67 was applied to the polymer substrate 61 by ink jet printing. At that time, the mask layer 67 was formed so that the wiring pattern region was an opening, and the surface of the polymer substrate on which the plating base was formed was exposed in that opening. The mask layer 67 was then cured by irradiating with UV light.

Next, a first Cu film 68 was formed by electroless plating on the surface of the side of the three-dimensional surface 61b of the polymer substrate 61 (side on which the mask layer 67 is formed) (Step S16 in FIG. 15). At this time, the Cu film grows only at the surface region of the polymer substrate 61 which has been modified by permeation of the metal complex 65 and exposed in the opening 67a of the mask layer 67. In this example, the first Cu film 68 was formed at a film thickness of 1 to 2 μm. Furthermore, electroless plating was carried out in the following manner. The polymer substrate 61 on which the mask layer 67 was formed was immersed in a container containing an electroless copper plating aqueous solution (consisting of Okuno Chemical Industries, OPC700A, 100 mL/ and Okuno Chemical Industries, OPC700B, 100 mL/L) and the solution was stirred for 10 minutes under conditions of a temperature of 30° C. to plate copper on the surface region of the polymer substrate 61 exposed in the opening 67a of the mask layer 67.

Next, after performing the ultrasonic cleaning for the polymer substrate 61 with pure water and methanol, electrolytic plating (electro forming) was carried out by using the first Cu film 68 as an electrode to form a copper plated film 69 (a second plated film, which may also be referred to as the second Cu film) on the first Cu film 68 (Step S17 in FIG. 15). The thickness of the second Cu film 69 was 10 μm. Furthermore, electrolytic plating was carried out by using a known method. In this manner, the three-dimensional wires 64 (plated film) comprised of the first Cu film 68 and the second Cu film 69 were formed on the polymer substrate 61.

Next, the mask layer 67 was removed by washing with aqueous solution of sodium hydroxide (Step S18 in FIG. 15). In the manner described above, a polymer substrate 61 was produced in which the three-dimensional wires 64 comprised of a Cu film were formed on the three-dimensional surface 61b as shown in FIGS. 7A and 7B.

The use of the above-mentioned method for forming a plated film of this example makes it possible to easily form a high-quality plated film in a desired pattern on the three-dimensional surface of a polymer substrate, and form a fine and highly precise plated film pattern such as wiring.

### EXAMPLE 13

In Example 13, similarly as in Example 12, a plated film having a predetermined pattern was formed on a polymer substrate by using a different method from that of Example 12. Furthermore, in this example, an example is explained in which the method for forming a plated film of the present invention is applied when forming circuit wiring on a module substrate of a single-chip lens module which integrates a lens with an image sensor for detecting imaged formed by the lens in the form of electrical signals. In addition, the constitution of the lens module produced in this example was the same as in Example 4 (FIGS. 7A and 7B).

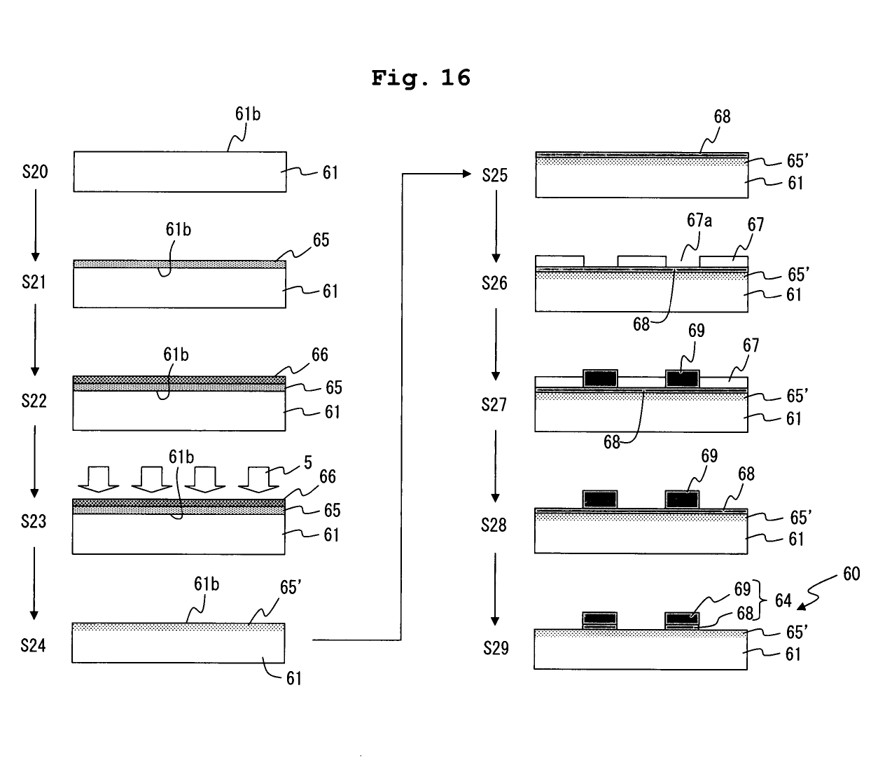

Next, an explanation is provided of the method for forming a plated film on the surface of a polymer substrate of this example with reference to FIG. 16. Furthermore, in the method for forming a plated film of this example, the step for preliminarily preparing a polymer substrate 61 (Step S20 in FIG. 16) to the step for forming a plating base (metal fine particles) 65′ by permeating a metal complex 65 into the surface 61b (three-dimensional surface) of polymer substrate 61 (Step S24 in FIG. 16) are the same as the steps of S10 to S14 in FIG. 15 explained in Example 12. Therefore, an explanation of the steps of S20 to S24 in FIG. 16 is omitted here, and an explanation is provided starting with Step S25.

After having formed a plating base 65′ at a predetermined region (region including a wiring pattern region) of the three-dimensional surface 61b of the polymer substrate 61, electroless plating was carried out on the surface of the side of the three-dimensional surface 61b (side on which plating base 65′ is formed) of the polymer substrate 61 to form a first Cu film 68 (first plated film) on the three-dimensional surface 61b of the polymer substrate 61 (Step S25 in FIG. 16). In this example, the thickness of the first Cu film 68 was 1 to 2 μn. Furthermore, electroless plating was carried out in the following manner. The polymer substrate 61 on which the mask layer 67 was formed was immersed in a container containing an electroless copper plating aqueous solution (consisting of Okuno Chemical Industries, OPC700A, 100 mL/L and Okuno Chemical Industries, OPC700B, 100 mL/L), and the solution was stirred for 10 minutes under conditions of a temperature of 30° C. to plate copper on the surface region of the polymer substrate 61. Next,the polymer substrate 61 was performed the ultrasonic cleaning with pure water and methanol.

Next, a photosensitive resin was applied on the first Cu film 68 formed by electroless plating. In this example, SU-10 manufactured by Kayaku Microchem was used for the photosensitive resin, and the coated thickness of the photosensitive resin was about 1 μm. Since a wiring pattern is formed on the three-dimensional surface 61b of the polymer substrate 61 in this example, the photosensitive resin was applied on the first Cu film 68 by ink jet printing so that the region corresponding to the wiring pattern region was in the form of an opening. Next, the photosensitive resin was cured by irradiating with UV diffuse light from the side to which the photosensitive resin was applied to form a mask layer 67. In this manner, the mask layer 67, in which the region corresponding to the wiring pattern region was an opening 67a, was formed on the first Cu film 68 (Step S26 in FIG. 16).

Next, electrolytic plating (electro forming) was carried out by using the first Cu film 68 as an electrode. Furthermore, electrolytic plating was carried out by using a known method. At this time, a copper plated film 69 (second plated film, which may also be referred to as the second Cu film) is formed on the first Cu film 68 exposed in the opening 67a of the mask layer 67 (Step S27 in FIG. 16). Namely, the second Cu film 69 is formed only at the opening 67a of the mask layer 67 corresponding to the wiring pattern region. In this example, the thickness of the second Cu film 69 was 10 μm. Next, the mask layer 67 was removed by washing with aqueous solution of sodium hydroxide (Step S28 in FIG. 16).

Next, dry etching was carried out on the polymer substrate 61 on which the first and second Cu films were formed. Although the first Cu film 68 and second Cu film 69 are formed on the wiring pattern region (region where the plated film is to be formed), since only the first Cu film 68 is formed at regions other than the wiring pattern region, the thickness of plated film at those regions other than the wiring pattern region is thinner than the thickness of the plated film formed at the wiring pattern region. Therefore, this etching step results in the plated film formed at regions other than the wiring pattern region being removed before the plated film formed at the predetermined pattern region. As a result, only a plated film 64 (the first Cu film 68+the second Cu film 69) formed in the opening 67a of the mask layer 67 remains on the three-dimensional surface 61b of the polymer substrate 61, and a polymer substrate is obtained in which a plated film is formed on the surface thereof in a predetermined wiring pattern (Step S29 in FIG. 16). In this example, in the manner described above, the polymer substrate 61 was produced in which the three-dimensional wires 64 comprised of a Cu film were formed on the three-dimensional surface 61b as shown in FIGS. 7A and 7B.

The use of the above-mentioned method for forming a plated film of this example makes it possible to easily form a high-quality plated film in a desired pattern on the three-dimensional surface of a polymer substrate similarly as in Example 12, and form a fine and highly precise plated film pattern such as wiring.

Moreover, in the method for forming a plated film of this example, since a thin first Cu film formed by electroless plating is formed over a wide range (predetermined region), which includes a wiring pattern region, on the surface of a polymer substrate, in the subsequent electrolytic plating step, the first Cu film is easily used as an electrode. Therefore, the method for forming a plated film of this example is effective as a method offering greater versatility.

### EXAMPLE 14

In Example 14, similarly as in Examples 12 and 13, a plated film having a predetermined pattern was formed on a polymer substrate by using a different method from that of Examples 12 and 13. Furthermore, in this example, an example is explained in which the method for forming a plated film of the present invention is applied when forming circuit wiring on a module substrate of a single-chip lens module which integrates a lens with an image sensor for detecting imaged formed by the lens in the form of electrical signals. In addition, the constitution of the lens module produced in this example was the same as in Example 4 (FIGS. 7A and 7B).

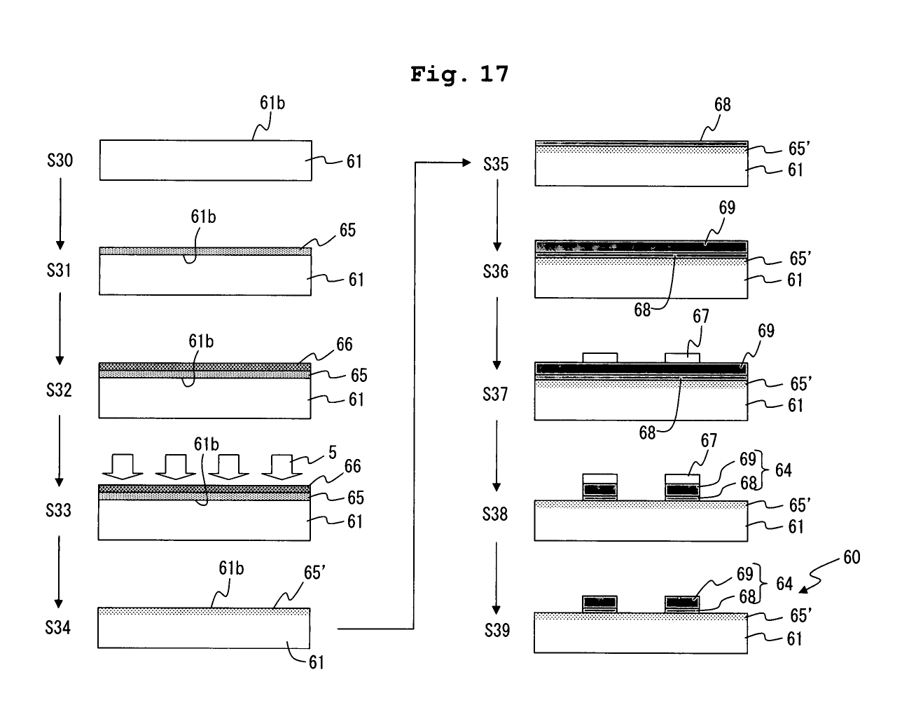

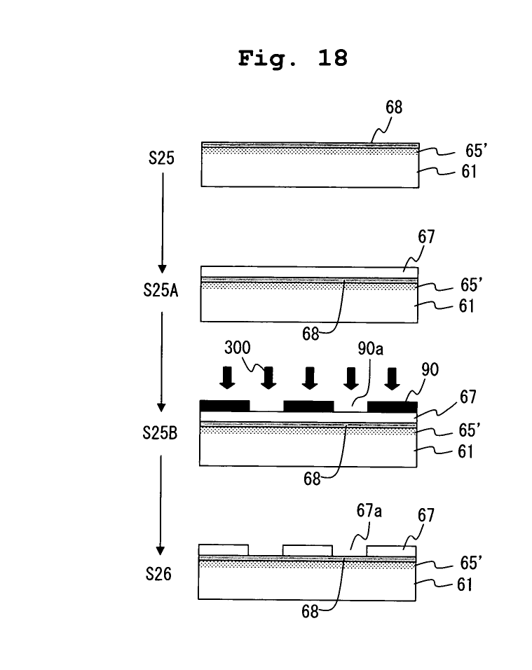

Next, an explanation is provided of the method for forming a plated film on the surface of a polymer substrate of this example with reference to FIG. 17. Furthermore, in the method for forming a plated film of this example, the step for preliminarily preparing a polymer substrate 61 (Step S30 in FIG. 17) to the step for forming a plating base (metal fine particles) 65′ by permeating a metal complex 65 into the surface 61b (three-dimensional surface) of polymer substrate 61 (Step S34 in FIG. 17) are the same as the steps of S10 to S14 in FIG. 15 explained in Example 12. Therefore, an explanation of the steps of S30 to S34 in FIG. 17 is omitted here, and an explanation is provided starting with Step S35.

After having formed a plating base 65′ at a predetermined region (region including a wiring pattern region) of the three-dimensional surface 61b of the polymer substrate 61, electroless plating was carried out on the surface of the side of the three-dimensional surface 61b (side on which plating base 65′ is formed) of the polymer substrate 61 to form a first Cu film 68 on the three-dimensional surface 61b of the polymer substrate 61 (Step S35 in FIG. 17). In this example, the thickness of the first Cu film 68 was 1 to 2 μm. Furthermore, electroless plating was carried out in the similar manner as Example 13.

Next, electrolytic plating (electro forming) was carried out by using the first Cu film 68 as an electrode to form a second Cu film 69 on the first Cu film 68 (Step S36 in FIG. 17). Furthermore, electrolytic plating was carried out by using a known method. In this example, the thickness of the second Cu film 69 was 10 μm.

Next, a UV curable resin was applied to the surface region of the second Cu film 69 corresponding to a wiring pattern region by ink jet printing. Next, the UV curable resin was cured by irradiating with UV light. In this manner, a mask layer 67 was formed on the surface region of the second Cu film 69 corresponding to the wiring pattern region (Step S37 in FIG. 17). In this example, the mask layer 67 was formed so as to cover the surface region of the second Cu film 69 corresponding to the wiring pattern region.

Next, the polymer substrate 61 on which the mask layer 67 was formed was immersed in an etching solution to carry out wet etching and remove the plated film (the first Cu film 68 and second Cu film 69) at the region not covered by the mask layer 67 (region other than the wiring pattern region) (Step S38 in FIG. 17). Furthermore, aqua regia, aqueous solution of iodine/potassium iodide, aqueous solution of iodine/ammonium iodide/methanol or the like can be used for the etching solution. Next, the polymer substrate 61 was washed with aqueous solution of sodium hydroxide to remove the UV curable resin on the wiring pattern (Step S39 in FIG. 17). In this example, in the manner mentioned above, a polymer substrate 61 was produced in which the three-dimensional wires 64 comprised of a Cu film were formed on the three-dimensional surface 61b as shown in FIGS. 7A and 7B.

The use of the above-mentioned method for forming a plated film of this example makes it possible to easily form a high-quality plated film in a desired pattern on the three-dimensional surface of a polymer substrate similarly as in Example 12, and form a fine and highly precise plated film pattern such as wiring.

Furthermore, in the method for forming a plated film of Example 14, the polymer substrate 61, in the state of having formed the plated film 64 (the first Cu film 68 and second Cu film 69) at a region over a wide range, which includes a wiring pattern region, on the polymer substrate 61 (the polymer substrate 61 in the state shown in Step S36 in FIG. 17), may be distributed in the form of a wired board product. In this case, the purchaser is not required to carry out a plating process, and a desired wiring pattern can be formed with a photolithography step only. Therefore, a wiring board can be provided which creates a small burden from the viewpoints of the equipment and the process. Furthermore, in this case, the plated film is preferably formed at region covering a broad range including the wiring pattern region of the polymer substrate 61 (and preferably over the entire surface thereof).

In the above-mentioned Examples 12 to 14, although examples were explained in which a plated film of a predetermined pattern is formed on the three-dimensional surface of a polymer substrate, the present invention is not limited thereto. The method for forming a plated film explained in the above-mentioned Examples 12 to 14 can also be applied to the case of forming a plated film of a predetermined pattern on a flat surface of a polymer substrate, and similar effects are obtained. In addition, the following provides a description of variations used when forming a plated film of a predetermined pattern on a flat surface of a polymer substrate.

### Variation 1

In Variation 1, an explanation is provided of a variation of the method for forming a plated film of Example 13. In Variation 1, the steps for forming the mask layer 67, in which a region corresponding to a wiring pattern region is an opening 67a, on the surface of the polymer substrate 61 on which a first Cu film 68 is formed, namely the steps from Step S25 to Step S26 in FIG. 16, are different from those of Example 13. The other steps are the same as in Example 13. Therefore, an explanation is only provided for the steps from Step S25 to Step S26 in this example.

The procedure for the steps for forming the mask layer 67, in which a region corresponding to a wiring pattern region is an opening 67a, on the surface of the polymer substrate 61 on which a first Cu film 68 is formed (steps from Step S25 to Step S26 in FIG. 16) in the method for forming a plated film of this example is shown in FIG. 18. In this example, a photosensitive resin (resist) was first coated onto the first Cu film 68 formed on the surface of the polymer substrate 61 (on the polymer substrate 61 in the state shown in Step S25 in FIG. 18). The thickness of the photosensitive resin was about 1 μn. Next, the polymer substrate 61 coated with the photosensitive resin was dried and then cured by cooling at room temperature. In this manner, a mask layer 67 was formed on the first Cu film 68 (Step S25A in FIG. 18).

Next, a photo mask 90, in which a region corresponding to a wiring pattern region is an opening, is covered over the mask layer 67. Furthermore, although the photomask 90 can be formed of any material having the property of blocking light, a metal such as Cr is used particularly preferably. In addition, the present invention is not limited thereto, but rather ink composed of a material having the properties of blocking light and adhering/tightly-adhering to the surface of the polymer substrate may be printed in a non-exposure region (region other than the wiring pattern region) to form the mask layer 67. In this case, the method for forming a plated film of this example can also be applied to the three-dimensional surface of a polymer substrate.

Next, exposure treatment was carried out by irradiating with UV diffuse light 300 from above the photomask 90 (Step S25B in FIG. 18). At this time, only the region of the mask layer 67 exposed in the opening of the photomask 90 is exposed.

Next, the mask layer 67 made from a photosensitive resin was developed with a exclusive developing solution at ordinary temperature to remove the photosensitive region of the mask layer 67. Next, the polymer substrate 61 was rinsed with water. In this manner, mask layer 67, in which a region corresponding to the wiring pattern region was an opening 67a, was formed on the surface of the polymer substrate 61 on which the first Cu film 68 was formed (state shown in Step S26 in FIG. 18).

### Variation 2

In Variation 2, an explanation is provided of a variation of the method for forming a plated film of Example 14. In Variation 2, the steps for forming a mask layer 67 on a region corresponding to a wiring pattern region on the surface of a polymer substrate on which a plated film 64 (a first Cu film 68 and second Cu film 69) was formed, namely the steps from Step S36 to Step S37 in FIG. 17, are different from those of Example 14. The other steps are the same as in Example 14. Therefore, an explanation is only provided for the steps from Step S36 to Step S37 in this example.

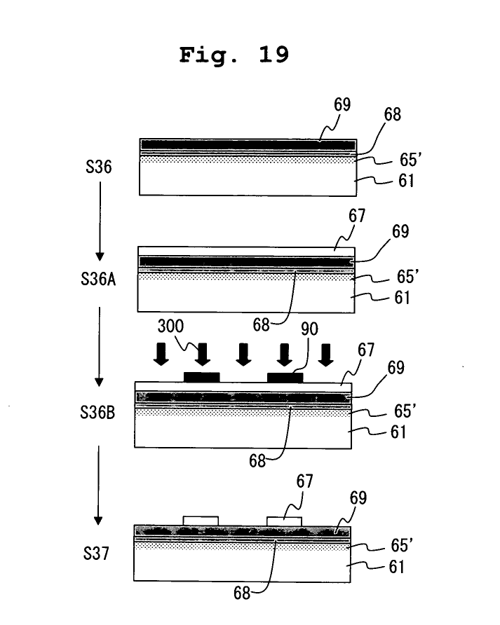

The procedure for the steps for forming the mask layer 67 at a region corresponding to a wiring pattern region on the surface of a polymer substrate on which the first Cu film 68 and the second Cu film 69 have been formed (steps from Step S36 to Step S37 in FIG. 17) in the method for forming a plated film of this example is shown in FIG. 19. In this example, a photosensitive resin (resist) was first coated onto the second Cu film 69 formed on the polymer substrate 61 (on the polymer substrate 61 in the state shown in Step S36 in FIG. 19). The thickness of the photosensitive resin was about 1 μm. Next, the polymer substrate 61 coated with the photosensitive resin was dried and then cured by cooling at room temperature. In this manner, the mask layer 67 was formed on the second Cu film 69 (Step S36A in FIG. 19).

Next, a photomask 90 was covered over the region corresponding to the wiring pattern region on the mask layer 67. Namely, the photomask 90, in which a region other than the wiring pattern region is an opening, was covered over the mask layer 67. Furthermore, although the photomask 90 can be formed of any material having the property of blocking light, a metal such as Cr is used particularly preferably. In addition, the present invention is not limited thereto. For example, ink composed of a material having the properties of blocking light and adhering/tightly-adhering to the surface of the polymer substrate may be printed in a non-exposure region (region other than the wiring pattern region) to form the mask layer 67.

Next, exposure treatment was carried out by irradiating with UV diffuse light from above the photomask 90 (Step S36B in FIG. 19). At this time, only the region of the mask layer 67 exposed in the opening of photomask 90 (region other than the wiring pattern region) is exposed.

Next, the mask layer 67 made from a photosensitive resin was developed with an exclusive developing solution at ordinary temperature to remove the photosensitive region of the mask layer 67. Next, the polymer substrate 61 was rinsed with water. In this manner, the mask layer 67 was formed at a region corresponding to the wiring pattern region on the surface of the second Cu film 69 (state of Step S37 in FIG. 19).

Both of the above-mentioned Variations 1 and 2, similarly as in Examples 12 to 14, make it possible to easily form a high-quality plated film in a desired pattern, and form a fine and highly precise plated film pattern such as wiring.

Although examples of permeation by applying a metal complex to a predetermined region of a polymer substrate surface have been explained in the above-mentioned Examples 12 to 14 and Variations 1 and 2, the present invention is not limited thereto. A metal complex may be permeated by applying to the entire surface of the polymer substrate.

In addition, although examples of forming a plated film by combining electroless plating and electrolytic plating have been explained in the above-mentioned Examples 12 to 14 and Variations 1 and 2, the present invention is not limited thereto. The plated film may also be formed by electroless plating only.

As described above, in the method for forming a plated film on a polymer substrate of the present invention, a high-quality plated film can be easily formed in a desired pattern regardless of the shape of the surface of polymer substrate on which the plated film is formed (e.g., three-dimensional or flat), and a fine and highly precise plated film pattern such as wiring can be formed. Therefore, the method for forming a plated film on a polymer substrate of the present invention is optimally suited as a method for forming all types of wiring boards.

In the above-mentioned Examples 1 to 14, although bolting was used to maintain the inside of the high-pressure container in a sealed state when bringing a supercritical fluid into contact with a polymer substrate, the present invention is not limited thereto, rather any means may be used. For example, a rotating type of cover sealing mechanism may be used. In addition, a method may also be employed in which, for example, a metal mold is attached to a pressing equipment and the mating face is sealed with the pressing force.

What is claimed is:

1. A surface modification method for a polymer substrate with a supercritical fluid, comprising:
applying a permeating substance to a surface of the polymer substrate; and
bringing the supercritical fluid into contact with the surface of the polymer substrate, to which the permeating substance has been applied, to cause the permeating substance to permeate into the polymer substrate.

2. The surface modification method according to claim 1, wherein the permeating substance is applied, in a predetermined pattern, to the surface of the polymer substrate when the permeating substance is applied to the surface of the polymer substrate.

3. The surface modification method according to claim 1, wherein the supercritical fluid is carbon dioxide in a supercritical state.

4. The surface modification method according to claim 1, wherein the polymer substrate is formed of a material selected from the group consisting of polymethyl methacrylate, polycarbonate, wholly aromatic polyamide, wholly aromatic polyester and amorphous polyolefin.

5. The surface modification method according to claim 1, wherein the permeating substance is an organic matter.

6. The surface modification method according to claim 1, wherein the permeating substance is dissolved in the supercritical fluid.

7. The surface modification method according to claim 5, wherein the permeating substance is a coloring matter.

8. The surface modification method according to claim 5, wherein the permeating substance is polyethylene glycol.

9. The surface modification method according to claim 1, wherein the permeating substance is a metal complex.

10. The surface modification method according to claim 9, further comprising forming a plated layer by electroless plating at a region to which the metal complex has been applied.

11. The surface modification method according to claim 1, wherein the permeating substance is applied by a screen printing or an ink jet printing when the permeating substance is applied to the surface of the polymer substrate.

12. The surface modification method according to claim 1, wherein the applying of the permeating substance to the surface of the polymer substrate includes forming a predetermined groove pattern in the surface of the polymer substrate, and applying the permeating substance to the groove pattern.

13. The surface modification method according to claim 1, wherein the surface of the polymer substrate to which the permeating substance is to be applied has a three-dimensional structure.

14. The surface modification method according to claim 1, wherein the applying of the permeating substance to the surface of the polymer substrate includes:
forming a mask layer, in contact with the polymer substrate, the mask layer having an opening in a predetermined pattern; and
applying a permeating substance to at least the opening of the mask layer.

15. The surface modification method according to claim 14, wherein the polymer substrate is prepared such that at least one of a concave portion and a convex portion is formed on the surface of the polymer substrate, the at least one of the concave portion and the convex portion corresponding to an opening of the mask layer.

16. The surface modification method according to claim 14, wherein the mask layer is formed of a polymer material.

17. The surface modification method according to claim 14, wherein the mask layer is formed by a printing.

18. The surface modification method according to claim 1, further comprising forming a coating layer so as to cover the permeating substance after the applying of the permeating substance to the surface of the polymer substrate.

19. The surface modification method according to claim 18, wherein the permeating substance is applied, in a predetermined pattern, to the surface of the polymer substrate when the permeating substance is applied to the surface of the polymer substrate.

20. The surface modification method according to claim 18, wherein the coating layer is formed by a method selected from the group consisting of dipping, roll coating, screen printing, and spraying.

21. The surface modification method according to claim 18, wherein the coating layer is formed of a material which has lower solubility in the supercritical fluid than the permeating substance.

22. The surface modification method according to claim 21, wherein the coating layer is formed of a water-soluble substance.

23. The surface modification method according to claim 19, wherein the polymer substrate is prepared such that a region of the predetermined pattern is formed in a concave portion of the polymer substrate.

24. The surface modification method according to claim 23, wherein the concave portion includes a groove pattern.

25. The surface modification method according to claim 18, wherein the applying of the permeating substance to the surface of the polymer substrate includes:
forming of a mask layer having an opening, in a predetermined pattern, on the polymer substrate; and
applying of the permeating substance to at least the opening of the mask layer.

26. The surface modification method according to claim 25, wherein the mask layer is formed by a printing.

27. The surface modification method according to claim 25, wherein the mask layer is formed of a polymer material.

28. The surface modification method according to claim 1, wherein the applying of the permeating substance to the surface of the polymer substrate includes:
applying the permeating substance, in a predetermined pattern, on a surface of a coating film; and
arranging the coating film on the polymer substrate.

29. The surface modification method according to claim 28, wherein the arranging of the coating film on the polymer substrate includes laminating the coating film and the polymer substrate so that the surface of the coating film to which the permeating substance has been applied faces the surface of the polymer substrate.

30. The surface modification method according to claim 28, wherein the coating film is formed of a material which has lower solubility in the supercritical fluid than the permeating substance.

31. The surface modification method according to claim 30, wherein the coating film is formed of a water-soluble substance.

32. A method for forming a plated film in a predetermined pattern on a surface of a polymer substrate, comprising:
applying a metal complex to the surface of the polymer substrate;
bringing a supercritical fluid into contact with the surface of the polymer substrate to cause the metal complex to permeate into the polymer substrate;
forming a plated film at a region which includes a region corresponding to the predetermined pattern on the surface of the polymer substrate into which the metal complex has permeated; and
forming a mask layer for patterning the plated film in the predetermined pattern.

33. The method for forming the plated film according to claim 32, wherein after permeating the metal complex into the polymer substrate,
the mask layer, in which a region corresponding to the predetermined pattern is an opening, is formed on the surface of the polymer substrate into which the metal complex has permeated, and
the plated film is formed in the opening of the mask layer.

34. The method for forming the plated film according to claim 33, wherein the forming of the plated film in the opening of the mask layer includes:
forming a first plated film by electroless plating on a portion of the surface of the polymer substrate, the portion being exposed in the opening of the mask layer, and
forming a second plated film by electrolytic plating on the first plated film.

35. The method for forming the plated film according to claim 32, wherein after permeating the metal complex into the polymer substrate,
a first plated film is formed by electroless plating on the surface of the polymer substrate to which the metal complex has permeated;
the mask layer, in which a region corresponding to the predetermined pattern is an opening, is formed on the first plated film;
a second plated film is formed by electrolytic plating on a portion of the first plated film, the portion being exposed in the opening of the mask layer;
the mask layer is removed; and
the first plated film formed at a region other than the region corresponding to the predetermined pattern is removed by etching.

36. The method for forming a plated film according to claim 32, wherein after permeating the metal complex into the polymer substrate,
the plated film is formed on the surface of the polymer substrate to which the metal complex has permeated;
the mask layer is formed on a region of the plated film, the region corresponding to the predetermined pattern; and
the plated film is removed by etching at a region in which the mask layer is absent.

37. The method for forming the plated film according to claim 36, wherein the forming of the plated film on the surface of the polymer substrate to which the metal complex has permeated includes:
forming a first plated film by electroless plating on the surface of the polymer substrate to which the metal complex has permeated, and
forming a second plated film by electrolytic plating on the first plated film.

38. The method for forming the plated film according to claim 32, further comprising forming a coating film so as to cover the metal complex after the applying of the metal complex to the surface of the polymer substrate.

39. The method for forming the plated film according to claim 32, further comprising reducing the metal complex to metal fine particles after permeating the metal complex into the surface of the polymer substrate.

40. The method for forming the plated film according to claim 32, wherein the mask layer is formed by one method selected from spraying, dipping, roll coating, screen printing, and ink jet printing.

41. The method for forming the plated film according to claim 32, wherein the surface of the polymer substrate to which the metal complex is to be permeated has a three-dimensional shape, and the mask layer is formed by an ink jet printing.

42. The method for forming the plated film according to claim 32, wherein the polymer substrate is formed of a material selected from the group consisting of polymethyl methacrylate, polycarbonate, wholly aromatic polyamide, wholly aromatic polyester and amorphous polyolefin.

43. A method for producing a polymer member, comprising:
preparing a polymer substrate;
applying a permeating substance to a surface of the polymer substrate; and
bringing a supercritical fluid into contact with the surface of the polymer substrate to which the permeating substance has been applied to cause the permeating substance to permeate into the polymer substrate.

44. The method for producing the polymer member according to claim 43, wherein the permeating substance is applied to the surface of the polymer substrate in a predetermined pattern when the applying of the permeating substance to the surface of the polymer substrate.

45. The method for producing the polymer member according to claim 43, wherein the supercritical fluid is carbon dioxide in a supercritical state.

46. The method for producing the polymer member according to claim 43, wherein the polymer substrate is formed of a material selected from the group consisting of polymethyl methacrylate, polycarbonate, wholly a romatic polyamide, wholly aromatic polyester and amorphous polyolefin.

47. The method for producing the polymer member according to claim 43, wherein the permeating substance is an organic matter.

48. The method for producing the polymer member according to claim 43, wherein the permeating substance dissolves in the supercritical fluid.

49. The method for producing the polymer member according to claim 47, wherein the permeating substance is a coloring matter.

50. The method for producing the polymer member according to claim 47, wherein the permeating substance is polyethylene glycol.

51. The method for producing the polymer member according to claim 43, wherein the permeating substance is a metal complex.

52. The method for producing the polymer member according to claim 51, further comprising forming a plated layer by electroless plating at a region to which the permeating substance has been applied.

53. The method for producing the polymer member according to claim 43, wherein the permeating substance is applied by a screen printing or an ink jet printing when the permeating substance is applied to the surface of the polymer substrate.

54. The method for producing the polymer member according to claim 43, wherein the applying of the permeating substance to the surface of the polymer substrate includes forming a predetermined groove pattern in the surface of the polymer substrate, and applying the permeating substance to the groove pattern.

55. The method for producing the polymer member according to claim 43, wherein the surface of the polymer substrate to which the permeating substance is to be applied has a three-dimensional structure.

56. The method for producing the polymer member according to claim 43, wherein the applying of the permeating substance to the surface of the polymer substrate includes forming a mask layer, in contact with the polymer substrate, the mask layer having an opening in a predetermined pattern, and applying the permeating substance to at least the opening of the mask layer.

57. The method for producing the polymer member according to claim 43, further comprising forming a coating layer so as to cover the permeating substance after the applying the permeating substance to the surface of the polymer substrate.

58. The method for producing the polymer member according to claim 57, wherein the applying of a permeating substance to the surface of the polymer substrate includes forming a mask layer, having an opening in a predetermined pattern, on the polymer substrate, and applying the permeating substance to at least the opening of the mask layer.

59. The method for producing the polymer member according to claim 43, wherein the applying of a permeating substance to the surface of the polymer substrate includes applying the permeating substance in a predetermined pattern on a surface of a coating film, and arranging the coating film on the polymer substrate.

60. A polymer substrate in which a surface thereof has been modified by using the surface modification method for the polymer substrate as defined in claim 1.

61. A polymer substrate in which a plated film formed in the predetermined pattern by the method for forming a plated film as defined in claim 32, is formed on the surface of the polymer substrate.

62. A coating member which is used to modify a surface of a polymer substrate, comprising:
a coating film; and
a permeating substance applied on the coating film to modify the surface of the polymer substrate with a supercritical fluid.

63. The coating member according to claim 62, wherein the permeating substance is formed on the coating film in a predetermined pattern.

64. The coating member according to claim 62, wherein the permeating substance is an organic matter.

65. The coating member according to claim 62, wherein the coating film is formed of a material which has lower solubility in the supercritical fluid than the permeating substance.

66. The coating member according to claim 65, wherein the coating film is formed of a water-soluble substance.
